(19) United States
(12) Patent Application Publication
(10) Pub. No.: US 2002/0170817 A1
(43) Pub. Date: Nov. 21, 2002

(54) Corona generator, reactor and method

(76) Inventor: Paul R. Goudy JR., Bayside, WI (US)

Correspondence Address: Warren A. Sklar, Renner, Otto, Boisselle & Sklar, LLP, 19th Floor, 1621 Euclid Avenue, Cleveland, OH, 44115-2191, US

(21) Appl. No.: 10/046,569

(22) Filed: Jan. 10, 2002

Related U.S. Application Data
(60) Provisional application No. 60/260,810, filed on Jan. 10, 2001.

(51) Int. Cl. H05F 3/00; B01J 19/08

(52) U.S. Cl. 204/164; 204/176; 422/186.07

(57) ABSTRACT

The invention provides for the generating of a corona or other electric discharge and provides for the passing of a gas through the corona to effect ionizing, creating of ozone or the like. The ionized gas, ozone, etc., may be used for various purposes, such as the disinfecting of water or some other material, the filtering of one material, such as iron, minerals, or other materials, from another or other function.

According to various methods of the invention, a corona discharge (or other electric discharge) is created, a gas is passed through the corona discharge; mixing of the gas may be provided by motionless mixing technique for one or more purposes, such as to assure maximum exposure of the gas to the corona discharge, to provide uniform temperature of the gas, to cool the corona generator, etc. According to one of the methods, too, a corona generator has an equivalent circuit of a plurality of capacitors, which may be charged in series and rapidly discharged in parallel.

### CROSS-REFERENCE TO RELATED APPLICATIONS

This application claims the benefit of U.S. Provisional Application Serial No. 60/260,810, filed Jan. 10, 2001.

### TECHNICAL FIELD

The invention relates to the developing or generating of a corona, the controlling of a corona, and the use of a corona and more particularly using the corona to create ozone or ionized oxygen which can be used for purposes such as the purifying of water and/or for other purposes, too. The invention also relates to a reactor for creating and using ozone or ionized oxygen and to a method.

### BACKGROUND

A corona is known classically as a low intensity diffused electrical discharge, this in comparison, for example, to a high intensity electrical discharge which typically is referred to as an electric arc.

Due to the diffusing nature of the electrical discharge of a corona, when examining a corona in close detail one can see that the corona in effect is a combination of a large number of very small electric arcs.

In early devices used to create a corona a dielectric material was placed between a pair of electrodes and in some instances was bonded to one of those electrodes. Upon applying electrical energy to the electrodes, a corona was developed in the free space between the dielectric material and the other electrode. If the dielectric were not bonded to one of the electrodes, the corona may occur between the dielectric material and both electrodes. The occurrence of the corona is caused by the low intensity diffused electrical discharge between the electrodes and the distribution of that electrical discharge in the gaseous medium between the electrodes. The gaseous medium itself breaks down, ionizing as the electrons are added or stripped with respect thereto.

In the early corona generating devices the electrical energy usually caused a substantial build up of heat. The generating of such heat can be wasting energy and the heat itself may detrimentally affect various components of the system. One effort to reduce heat load on prior corona generating devices was to use a water cooled electrode or water electrodes in the device.

A problem typically encountered in prior corona generating devices, including the early ones and more modern ones, is the tendency of the low intensity diffused electrical discharge to migrate toward a local area in the dielectric. As the electrical discharge migrates to a local area, the discharge through other areas is interrupted or diminishes, the discharge at the local area tends to increase and may cause an electrical arc, the larger discharge and/or electrical arc at the local area tends to cause localized heating of the dielectric, and, ultimately, as a result of that heating and/or high intensity discharge at the localized area ultimately the dielectric overheats and fails. Also, when the low intensity diffused electrical discharge has been interrupted at other areas of the dielectric, the efficiency of corona generation will diminish.

It would desirable to generate a corona and to control the corona to reduce or to avoid such migration and to reduce or to eliminate one or more of the aforementioned prior problems.

It also would be desirable to provide suitable control of a corona and the apparatus generating the corona so that the low intensity diffused electrical discharge is at a rate which is sufficient to cause a desired ionization of the free gas that is being bathed by the electrical discharge and to avoid or to reduce ionization of the free gas beyond that which the target gas, e.g., air or some other gas, can accept. As is described in further detail below, such control may be, for example, the controlled providing of electrical charge to supply a desired number of or to remove a desired number of electrons from such gas, say to achieve a particular valence condition of the treated gas to optimize the stoichiometric recombination of gases to achieve a desired output. One example is the treating of oxygen to change its valence so that there is a prescribed recombination that results in the efficient generating of ozone.

As is known, when an electrical discharge is created between a pair of electrodes, the uniformity of the discharge may vary as a function of the spacing and/or other conditions existing between or relative to the electrodes. For example, if a pair of planar electrodes were arranged such that at one area between the electrodes the spacing is smaller than at another area, there would tend to be a greater amount of discharge/current flow at such more closely spaced area than at the further spaced area. The spacing of electrodes can vary for a number of reasons. One may be due to imperfections in the nature of the dielectric between the electrodes. As an example, glass may be used as the dielectric; as is well known, glass rarely has a precise thickness and smoothness over its area, and such variations in thickness or smoothness can change the spacing between electrodes at localized areas, particularly when one electrode is bonded to the dielectric, e.g., glass, or other dielectric material. Also, when a fluid, such as a gas, is directed between electrodes or simply is located in that area, such fluid may contain a pollutant or ingredient that may accumulate on one of the electrodes resulting in an effective reduction in the spacing between the electrodes. For example, dust may build up at a particular area on one electrode, and the dust may become an effective extension of the electrode thereby tending to reduce the gap relative to the opposite electrode. Furthermore, as temperatures vary over the area of an electrode, one area may expand a different amount than another area, and this too, can cause variations in spacing between electrodes. The non uniformity of spacing of the electrodes may be compounded in the event that the electrical discharge tends to migrate to an area where the electrodes are closer to each other because the increased discharge at that area tends to cause further heating and, thus, expansion of the electrodes. If the area becomes too hot or the discharge at an area becomes too intense, an electric arc sufficient to cause a localized corona stream, for example, may occur, which in turn causes further heating and still further compounding the problems due to expansion with temperature.

Another problem encountered in prior systems providing electrical discharge between a pair of generally parallel electrodes includes the different conductivity of the medium between the electrodes. For example, if the medium were a gas that is combined with water or water vapor, the electrical resistance tends to decrease and the possibility of a current leakage path, electric arc, etc., existing at a particular area between the electrodes increases. Also, as is known, the ionization potential of a material between a pair of electrodes may vary with the particular material. Air, water, oxygen and nitrogen each has a different respective ionization potential, i.e., the voltage at which the material ionizes. Increasing the moisture content of the gas, such as wet air, for example, also can change the ionization potential of the gas between the electrodes.

In view of the above, then, it would be desirable to be able accurately to maintain the spacing tolerance of a pair of electrodes and especially to maintain that spacing tolerance for a pair of electrodes used for generating a corona. Additionally or alternatively it would be desirable to increase the tolerance of a corona generator to non-uniform spacing of the electrodes.

Compounding even further the aforementioned problem of changes in spacing between electrodes, such as electrodes used in prior corona generating devices is the fact that such devices typically have employed a continuous flow of electrical energy to the electrodes without providing any shut off or interruption of the electrical energy. As a result, continuous energy is delivered and heating, especially by an electric arc or plasma stream that may occur, may be continuous and continue to intensify, thus exacerbating the aforementioned problems.

An example of a prior corona discharge device is described in the text Ozone Treatment of Industrial Wastewater by Rice and Browning, Noyes Data Corporation, 1981, pages 14-37 and in Handbook of Chlorination, by George Clifford White, Van Nostrand Reinhold Company, New York, 1986, pages 927-945. Prior techniques for generating ozone have used a parallel plate technology. The parallel plates may be flat or cylindrical, and in the later case the cylinders, of course, are concentric. Accurate spacing of the parallel plates is required to try to avoid a preferential discharge. The ozone generator, sometimes referred to as a reactor, uses the two parallel plates as electrodes which are spaced or separated by a dielectric, such as air. As the voltage is increased, a corona results in the space between the two electrodes.

It is difficult to maintain the accurate spacing of the electrode plates, and it also is costly to do so. Furthermore, it is unusual to maintain perfectly accurate spacing, and, therefore, usually preferential discharge spots occur, and, therefore, the corona or discharge is non-uniform between the plates. Also, to assure adequate exposure of the gas, such as oxygen, to generate ozone by the discharge, the size of the prior art devices had to be sufficiently large to assure the flowing gas would pass through the corona, which often was non-uniform. It would be desirable to increase the efficiency of generating ozone in an ozone generator or reactor. It also would be desirable to reduce the size of an ozone generator that produces an efficient ozone output.

It has been found in the past that the larger the ozone generator electrode plates, the more difficult it is to maintain accurate spacing and the more likely preferential discharge spots will occur. A problem with a preferential discharge spot is the localized heating that occurs there, which can cause a localized stress formation and/or a failure. Also, the larger or the more preferential discharge spots, the less uniform is the discharge between the electrodes plates, and the less likely that all of the gas flowing between the plates will encounter discharge and, thus, become ionized and/or a result in ozone. Furthermore, such devices may be overdriven to try to obtain larger corona discharges and/or increased uniformity; but overdriving by excess voltage may be inefficient and also can cause heating where there is a preferential discharge, hot spot, arcing, etc.

In the past it was necessary to maintain relative flatness of dielectric materials for uniformity, but this was difficult and sometimes not possible. It would be desirable to reduce the tolerance requirements for flatness, spacing, etc., in an electric discharge device, such as a corona generator and ozone generator.

### SUMMARY

An aspect of the invention relates to the use of ozone to disinfect water or other medium.

Another aspect of the invention relates to the generating of ozone and delivering of the ozone to water or other medium for disinfecting purposes.

Another aspect of the invention relates to the generating of ozone and delivering of the ozone to water or other medium for filtering purposes.

Another aspect of the invention relates to the generating of ozone and delivering of the ozone to water or other medium for chemical reaction purposes.

Another aspect relates to the developing of or generating of ionized gas, especially ionized oxygen. Still another aspect relates to the use of such ionized gas to provide disinfecting and similar functions.

Accordingly, an aspect of the invention is to improve the uniformity of discharges in an ozone generator.

Another aspect is to assure that gas flowing through a corona generator does flow through areas of discharge.

Another aspect of the invention is to make the discharge points very small in an ozone generator, thus minimizing cost and facilitating accurate supporting and spacing of the electrodes. This allows setting tolerance limits on a large device that are significantly broader than was possible in prior art devices using parallel reactors, such as those disclosed in the aforementioned texts.

An aspect of the invention is to distribute charge over a large portion of an ozone generator device or other reactor to provide more uniformity of discharge, to control heat build up on the dielectric, and to assure the gas flowing through the discharge is exposed to the discharge.

Another aspect is to hold very close tolerances over large areas of a discharge device, such as an ozone generator, reactor, etc.

Another aspect is to direct the flow of gas through known discharge points in an ozone reactor or the like and to try to avoid the likelihood of the gas circumventing those discharge points, such as due to a pressure differential, internal irregularities in the device, etc.

Another aspect is to provide current limiting characteristics for an electric discharge reactor device, and a further aspect is to provide such control to avoid burning or excessive heating of the device.

Another aspect is to improve the uniformity of charge distribution and discharges in a discharge reactor device.

Another aspect is to reduce the voltage requirement to obtain discharges in a discharge reactor device, and a corollary aspect is to improve the longevity of such a device due to the reduced operating voltage requirement.

A further aspect is to facilitate providing relatively high tolerance in a discharge reactor, and, accordingly, to improve the uniformity of the discharge.

Another aspect is to provide a method and apparatus for ionizing oxygen and minimizing ionization of nitrogen in air.

Another aspect is to facilitate purifying or disinfecting a fluid, such as water by supplying ionized air and/or ozone thereto.

Another aspect is to ionize a fluid and to supply that fluid to a liquid, such as water, to facilitate removing material, such as iron from the water.

Another aspect is to mix a fluid flowing through a discharge reactor, for example, by motionless mixer technique or the like, while supplying electrical discharges and/or ionizing function in the reactor and exposing the fluid thereto.

Another aspect to disinfect water in a localized area, such as a jug or tank by directly delivering to the container ozone in amounts effective to cause such disinfecting function.

Another aspect is to kill bacteria, an example being cryptosporidium by directing ionized oxygen and/or ozone to water containing that material.

Another aspect relates to the filtering of material from a liquid by bubbling a gas through the liquid.

Another aspect is to bubble a gas through a liquid that has a particulate material in it and to precipitate out that particulate using the gas to pull such particulate out of the liquid.

To the accomplishment of the foregoing and related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Although the invention is shown and described with respect to one or more preferred embodiments, it is obvious that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

In the annexed drawings:

FIG. 1 is a schematic illustration of a corona discharge system using an uninsulated electrode and an insulated electrode;

FIG. 2 is a schematic illustration of a corona discharge system using two insulated electrodes;

FIG. 3 is a schematic illustration of a corona discharge system using a pair of liquid electrodes that are contained in insulating containers;

FIGS. 4 and 5 are schematic illustrations depicting operation of the corona generator system of FIG. 3;

FIGS. 6 and 7 are schematic side and end views of a corona generator system using an insulated electrode and a liquid electrode that is insulated;

FIGS. 8 and 9 are top and elevation schematic views of a corona generator system for generating a plurality of coronas;

FIGS. 10-12 are schematic illustrations of a corona generator system that provides motionless mixer function and a plurality of coronas along the fluid flow path;

FIGS. 13-15 are schematic illustrations of an alternate embodiment of corona generator system using motionless mixer function and a plurality of coronas generated by screen-like electrode(s);

FIG. 16 is a schematic elevation view of a corona generator system immersed in a liquid;

FIG. 17 is a schematic illustration of another corona generator system immersed in a liquid;

FIG. 18 is a schematic illustration of an alternate electrode arrangement for the corona generator system of FIG. 17 which provides for fluid pumping action.

FIG. 19 is a schematic illustration of a corona generator system having multiple air flow paths;

FIG. 20 is a schematic illustration of a corona generator system having an immersable reactor and disconnectable power sections;

FIG. 21 is a schematic illustration of another embodiment of immersable corona generator systems;

FIG. 22 is a fragmentary schematic illustration of a modified air distribution section for use, for example, with the corona generator system of FIG. 21;

FIGS. 23 and 24 are schematic illustrations of an elongate tubular corona generator system in which a reflected air flow path is provided;

FIG. 25 is a schematic illustration of a corona generator system providing a corona curtain for exhaust gas remediation;

FIG. 26 is a schematic illustration of another corona generator system for providing a corona curtain for exhaust gas remediation;

FIGS. 27-30 are schematic illustrations of a mounting structure for the electrodes of the corona generator system of FIG. 26;

FIG. 31 is a schematic view of a corona generator in accordance with an embodiment of the invention;

FIGS. 32a-32d, respective illustrations of the wire input electrode 504 are shown at different respective times during operation of the corona generator of FIG. 31;

FIG. 33 is a schematic circuit drawing of respective parallel capacitors for discharging of the corona generator of FIGS. 31 and 32;

FIG. 34 is a section view through a fragment or portion of a modified corona generator;

FIG. 35 is a fragmentary side section view of another embodiment of corona generator of the invention;

FIGS. 36-38 are, respectively side, top, and end views of the support holder for the coil input conductor of the corona generator of FIG. 35;

FIG. 39 is a schematic isometric view, partially broken away, of another embodiment of corona generator according to the invention;

FIG. 40 is a schematic end elevation view of the corona generator of FIG. 39;

FIG. 41 is a somewhat isometric, partially broken away expanded elevation view of a circular cylindrical corona generator according to the invention;

FIGS. 42 and 43 are, respectively, fragmentary side section and top views of the corona generator of FIG. 41;

FIG. 44 is a side elevation schematic view of another corona generator according to the invention using a threaded rod support;

FIG. 45 is a side elevation schematic view of another corona generator according to the invention using a threaded rod support and having cuts in the support to separate respective effective capacitor portions thereof;

FIG. 46 is a schematic circuit drawing of respective parallel capacitors for discharging of the corona generator of FIG. 45;

FIGS. 47 and 48 are schematic bottom and top views of a corona generator similar to the corona generator of FIG. 44 but with discontinuities in the counter electrode—the side view are similar to the top view of FIG. 48;

FIG. 49 is a schematic side elevation view of another embodiment of corona generator with twisted input electrode wires;

FIG. 50 is a schematic end section view of the corona generator of FIG. 49;

FIG. 51 is a plan view of a modified wire holder for use in the corona generator of FIGS. 49-50, including slot-like openings to concentrate discharge to create an electric arc discharge rather than a corona; and

FIG. 52 is a schematic side elevation view of another embodiment of corona generator similar to the corona generator of FIG. 49 with twisted input electrode wires and here also with dielectric beads between wire holder plates or discs.

### DESCRIPTION

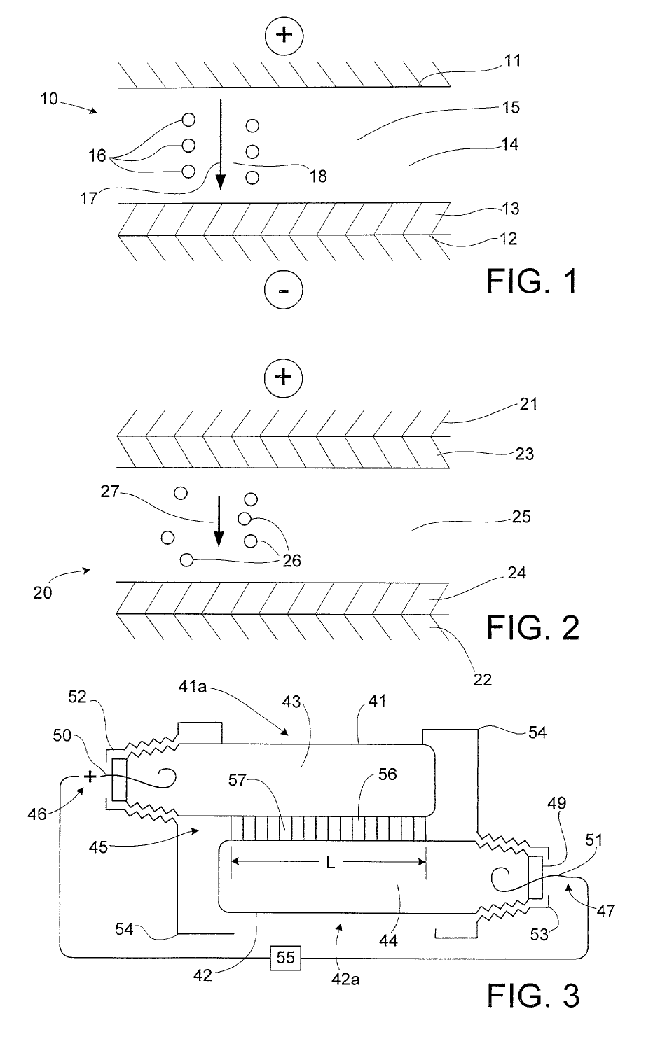

Referring to the drawings in which like reference numerals designate like parts in form, structure or function, and initially to FIG. 1 for background information, an electrical discharge system 10 is shown. The electrical discharge system 10 includes a pair of spaced apart parallel electrodes 11, 12 and a dielectric 13 at one of the electrodes, for example the electrode 12. The electrodes 11, 12 may be metal and the dielectric 13 may be glass. Other materials may be used for these components, as is well known. In the space 14 between the electrodes is a fluid 15, several molecules 16 of which are schematically illustrated. Upon application of a voltage between the electrodes, 11, 12, an electric discharge would be expected. If such electric discharge were uniform, there would be a substantially uniform distribution of electrons flowing between the electrodes through the space 14. However, since the conductivity of an electrode, say electrode 11, usually is greater than the conductivity of the gas in the space 14, the electrons “e” in the electrode 11 will tend to migrate to a common location, build up by relatively large effective current there, and then transmit or flow to the opposite electrode. This can result in an electric arc or hot spot 17 where there is high electron density 18 between the electrodes whereby energy is concentrated at that hot spot area and the electric discharge at other areas in the space 14 between the electrodes 11, 12 will diminish. The electric discharge may be used in such an electric discharge system 10 for the purpose of stripping or adding a prescribed electron or number of electrons with respect to the molecules of the fluid 15 in the space 14. The increase in heat due to localized heating by the aforementioned hot spot 17 tends to change the characteristics of the molecules 16 such that they tend to add or to strip off more electrons than intended for optimal efficiency or optimal efficient use of the gas in a subsequent process. An example of the decreased efficiency of the electric discharge system 10 when such hot spots occur is the increased energy needed to strip electrons from molecules 16 after, for example, the first is stripped. The first electron typically is easiest to strip as it is located in the outer most electron shell; removing an electron from another shell required unnecessary energy and thus reduces efficiency.

In the corona generators discussed below there is a fluid material that is located between a pair of electrodes. The fluid material may be liquid or gas. Several embodiments described are presented using air as the fluid medium. It will be appreciated that other gases or liquids may be used. For example, the gas may be a pure gas, such as pure oxygen, pure nitrogen, etc. If the gas is air or some other mixture, control may be provided, if necessary, to generate the corona at an energy level able to ionize the gases in the mixture selectively. Thus, for example, the invention may be used to ionize the oxygen in air without ionizing or with substantially less ionizing of nitrogen contained in the air.

It will be appreciated that features of the invention shown and described with respect to one embodiment of the invention may be used with other embodiment(s) of the invention.

Turning to FIG. 2, a doubly insulated electric discharge system in accordance with one aspect or embodiment of the invention is shown at 20. The discharge system 20 may be considered analogous to an electrical capacitor that has a pair of electrodes 21, 22 and three dielectric layers 23, 24, 25. The dielectric layers 23 and 24 may be the same material or different materials. In the illustrated embodiment they are glass. They may be some other material. The dielectric layer 25 in the illustrated example is a fluid, preferably a gas. If the fluid 25 were a liquid, preferably it has a sufficiently high dielectric strength that it does not break down. The electrodes 21, 22 may be liquid, such as water or other suitable liquid, and the dielectric layers 23, 24 may be respective containers, such as parallel spaced apart tubes that contain the respective liquid electrodes 21, 22. The fluid 25 may be, for example, air, oxygen, or some other gas. Air is preferred when the system 20 is used in an ozone generating process.

In operation of the discharge system 20 a voltage (sometimes represented by + or − signs in the drawings) is applied across the liquid electrodes 21, 22. As a result of that voltage, electrons tend to be stripped from or added to respective molecules 26 of the fluid and there is an effective current flow represented by the arrow 27.

In the discharge system 10 of FIG. 1 prior to an electric discharge there may be a uniform distribution of electrons in the electrode 11, but upon the occurrence of discharge, electrons tend to migrate to the discharge site because it is an easier flow path for the electrons through the electrode itself than it is through the fluid 15. However, in the discharge system 20 of FIG. 2, the electrodes 21, 22 are insulated by the respective dielectric layers 23, 24 from the fluid 25. Therefore, the voltage across the electrodes 21, causes an electric field E to occur across the fluid 25. All electrons then must be provided by the fluid itself and not by electrons flowing from a respective electrode. This usually results in a more uniform discharge through the fluid 25 than the discharge through the fluid 15 of the discharge system 10 in FIG. 1.

Another feature of the discharge system 20 in FIG. 2 is the avoiding of corona discharges between an electrode at 21, 22 and the respective dielectric layer 23, 24. It is possible under certain circumstances that the spacing apart of one electrode from its adjacent dielectric layer may result in a discharge therebetween that would in effect create a localized corona or even an electric arc. It is desirable to avoid such a condition because the energy used in creating such corona or electric arc is wasted; it is not having any direct effect on the fluid 25. Also, such discharge may cause damage to and/or failure of the electrode and/or dielectric layer. To avoid such space between the electrode and the dielectric layer, a liquid electrode may be used. Using a liquid electrode that washes against the dielectric layer avoids space between the two and, therefore, avoids the likelihood of such a separate corona discharge or electric arc therebetween. A liquid electrode is “self healing.” For example, in the event there were to occur such a discharge or arc due to an air bubble in the liquid electrode 22 adjacent the dielectric layer 24, the liquid electrode in effect self heals and as the air bubble moves or is dissipated, the liquid fills the space and such discharge or electric arc also will extinguish.

Still another feature of the invention as illustrated in FIG. 2 is the use of the system as an electrical capacitor or operation similar to that of a capacitor. The fluid 25 would have a dielectric strength lower than that of the dielectric layers 23, 24. If the voltage applied across the electrodes 21, 22 becomes too high, an electric discharge may occur in the liquid 25. If the electric discharge becomes sufficiently large due to a concentration of electron flow, for example, at the arrow 27, the molecules in the area of the arrow 27 will tend to heat and to cause a circulation of the fluid 25. Such circulation tends to maintain the temperature of the fluid 25 relatively uniform throughout the fluid 25. Also, the circulation tends to cool the area where the mentioned discharge had occurred. The electric discharge then may occur at still another area in the fluid 25, and upon such occurrence further circulation would occur which results in cooling of that area, too. As a result, there is substantially uniform temperature throughout the fluid 25 and discharges that occur in the fluid tend to be distributed throughout the fluid, which helps to maintain the integrity and avoid breakdown of the capacitor itself even when large voltages are applied thereto.

Referring to FIG. 3, a schematic illustration of a corona generator 40 in accordance with one embodiment of the invention using features of the discharge system 20 of FIG. 2 is shown. The corona generator 40 includes a pair of tubular electrodes 41a, 42a formed of tubular enclosures 41, 42, each containing a liquid electrode material 43, 44. A gap 45 is between the two containers 41, 42. The containers 41, 42 may be elongated circular cylindrical or other shape, circular cylinders being preferred. The gap 45 extends along the space between the two cylinders and the two cylinders preferably are aligned on parallel axes in spaced apart relation to create the gap 45. A closure 46, 47 at the end of each container retains the liquid therein. An example of such a closure may be a silicone septum 48, 49 which is pierced by a wire 50, 51 and is held in place by a retainer 52, 53. The septum 48, 49 may be simply a disk of silicone or it may be some other material that is electrically non-conductive and is able both to retain fluid 43, 44 in the container and to pass the wire 50, 51 into the respective container from the outside. The containers 41, 42 may be made of glass or other dielectric material. The liquid 43, 44 may be water having sufficient minerals therein so that the water is electrically conductive. Other liquids also may be used instead of or in addition to the water. The system 40 includes a support structure or frame 54 for holding the containers 41, 42 in the illustrated orientation. A power supply 55 provides voltage across the wires 50, 51, and that voltage is electrically connected by the respective wires to the respective liquids 43, 44. When sufficient voltage is so applied, and a suitable gas 56 is supplied in the gap 45 a corona discharge 57 will occur in the gap 45. It has been found that the corona discharge remains substantially uniform over the length L of the gap substantially independently of minor irregularities in the surfaces of the respective containers 41, 42 or in the parallel gap spacing from one end to the other.

The ionizing of gas 56 in the gap 45 requires sufficient energy, for example, joules of energy from the power supply 55. It has been found that if the spacing of the gap 45 is non-uniform, the discharge will initiate at the area of the gap where the spacing between electrodes is minimized. Sufficient energy is necessary to cause an electric discharge at that area of minimum spacing. An electric arc usually will not occur because there are no bare metal surfaces exposed to provide electron flow directly therefrom. The extent along the length L of the gas that the corona will exist will depend on the magnitude of such energy, such as the number of joules provided by the power supply 55. If a relatively small amount of energy is provided, then the discharge only will occur along less than the entire length L. If the joules available from the power supply 55 are sufficient, then the corona discharge 57 will occur along the entire length L of the gap 45.

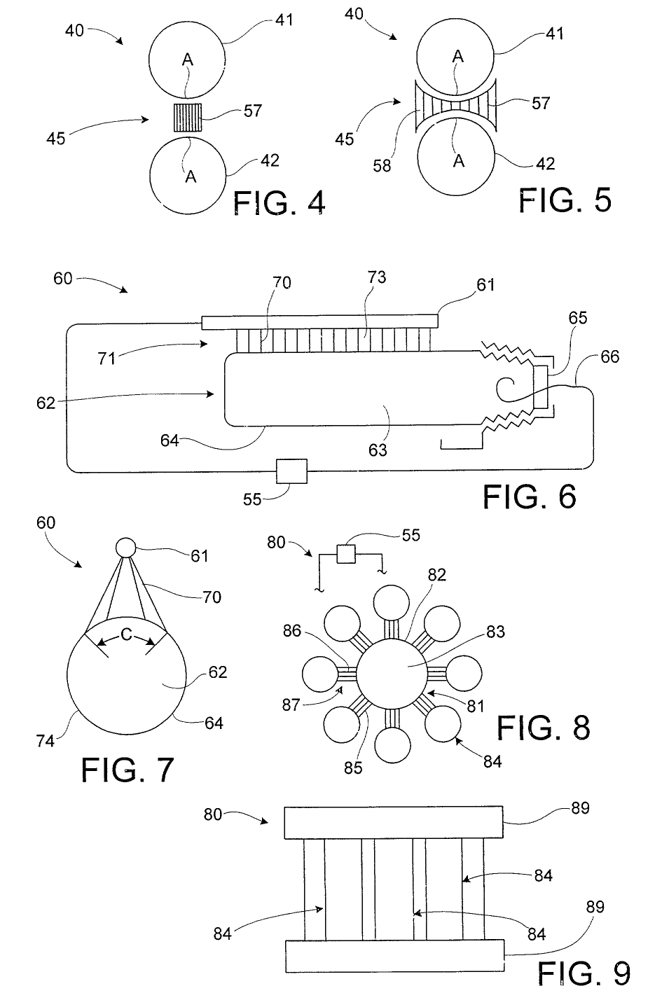

Referring to FIGS. 3-5, it also has been found, and is another feature of the invention, that within reasonable limits the system 40 is self limiting in that it avoids overloading the gas 56 with excessive electrons that in prior devices might cause a hot spot, for example. Since the containers 41, 42 are generally cylindrical, it is expected that the corona 57 initially will occur at one particular location between the two containers at the apex “A” of the curvature of each where the two containers are closest together, and the corona will spread along the length L of the gap. However, as the amount of joules provided the power supply 55 is increased, the corona tends to spread laterally, i.e., to follow around the curvature, on the respective containers providing in cross section something analogous an hour glass shape. In FIG. 4 is illustrated a pair of parallel tubular containers 41, 42 in end view, such as the containers in FIG. 3, and the corona 57 in the gap 45 is located primarily at the area of the apex of the respective curves of those cylinders where those cylinders are closest together. However, as is seen in FIG. 5, with the energy from the power supply 55 increased sufficiently, the corona 57 tends to expand laterally in the manner described. Such expansion may be due, for example, to the fact that the electrons already have been stripped from molecules near the apex of the respective curvatures of the containers 41, 42 and, therefore, when DC electrical power is supplied, those molecules are less electrically conductive in the direction of current flow driven by the power supply. Electrons more remote from the apices, then, subsequently in effect are sought to have electron stripped therefrom.

One example of the driving energy from the power supply 55 may be, for example, pulsed electrical power, for example, pulsed DC or AC power that has a steep enough slope so that it looks to the corona generator as a plurality of DC pulses. Other power also may be used.

In operation of the system 40, as the electric field is delivered by the electrodes 43, 44, electrons are stripped from molecules of the gas 56. It is more difficult to strip a second electron from a molecule than to strip the first, and, therefore, as the energy or joules is increased by the power supply 55, more electrons near the area 58 of the corona more remote from the area of the apexes A will begin having electrons stripped. Therefore, within a reasonable range of energy levels the system 40 is self limiting in power usage and corona generating functions and tends to avoid the creating of hot spots in the area of the corona 57.

In FIGS. 6 and 7 is illustrated an alternate embodiment of corona generator system 60, which is similar to the system 40 described above with reference to FIGS. 3-5 and also uses the combination of an uninsulated and insulated electrodes 61, 62, which may be similar to the electrodes 41a, 42a and electrode 11, respectively. The uninsulated electrode 61 may be a metal wire, such as copper, brass or some other material. The insulated electrode 62 may be a liquid 63, such as water, in a cylindrical tubular container that is closed at one end by a silicone disk 65 having a wire 66 therethrough. When a voltage is applied from a power supply 55 between the wire 66 and, thus, the liquid electrode 62, on the one hand, and the uninsulated electrode 61, on the other hand, a corona 70 is formed in the gap 71 between the electrodes. Since the electrode 61 is uninsulated, the corona 70 may not be as diffuse as the corona 57. However, since the electrode 61 is uninsulated, the magnitude of voltage required to ionize the gas 73 in the gap is less than the voltage required to ionize the gas 56 in the system 40 (FIG. 3). As is seen in FIG. 7, the shape of the corona 70 between the electrodes 61, 62 is somewhat triangular in shape or pie shape tending to radiate from the uninsulated electrode 61 toward the exterior surface 74 of the tubular container 64 along an arc C.

Another embodiment of double insulated electrode configuration corona generator is shown at 80 in FIGS. 8 and 9. In the corona generator 80 there is a first insulated electrode 81, which may be formed of a tubular container 82 and liquid 83, which may be similar to the tubular container 41 and liquid 43 described above with respect to the system of FIG. 3. A plurality of insulated electrodes 84 are located circumferentially about the tubular electrode 81. The electrodes 84 may be similar in construction to the electrode 81. By applying a voltage between the electrode 81 and each of the electrodes 84, coronas 85 can be generated. The actual size of the coronas 85 and where they first begin, i.e., between which electrode 84 and electrode 81 is the corona first formed, may depend on the spacing of respective electrodes 84 from electrode 81. A gas 86 is located in the gap or space 87 between respective electrodes 84 and the electrode 81, and the coronas 85 are generated as electrons are stripped from or added to respective molecules of the gas.

In FIG. 9 a support 88 (or frame) is shown schematically for retaining the electrodes in the positional relationship depicted in FIG. 8. The support 88 may include a base and a top with means to hold the respective tubular containers of the respective electrodes thereto. Electrical power source 55 provides appropriate electrical energization to the electrodes to generate the desired corona(s).

It will be appreciated that an uninsulated electrode such as electrode 61 of the embodiment of FIG. 6 may be substituted for one or more of the electrodes used in the system 80 of FIGS. 8 and 9. For example, such an uninsulated electrode may be substituted for one or more of the electrodes 84 located in spaced relation generally parallel to the axis of the tubular electrode 81. The uninsulated electrode(s) and/or the insulated electrodes preferably are oriented in relation to the electrode 81 such that the axes thereof are parallel. An advantage to using the configuration of insulated electrodes in the system 80 of FIG. 8 is that the electrodes 84 may be spaced relatively close to the electrode 81; and this would be the same if the uninsulated electrode 61 were used in place of one or more of the insulated electrodes 84. If the electrode 81 were an uninsulated one, then preferably it would be of a shape that provides sufficient proximity to the insulated electrodes 84 so that the desired corona discharge could be obtained therebetween.

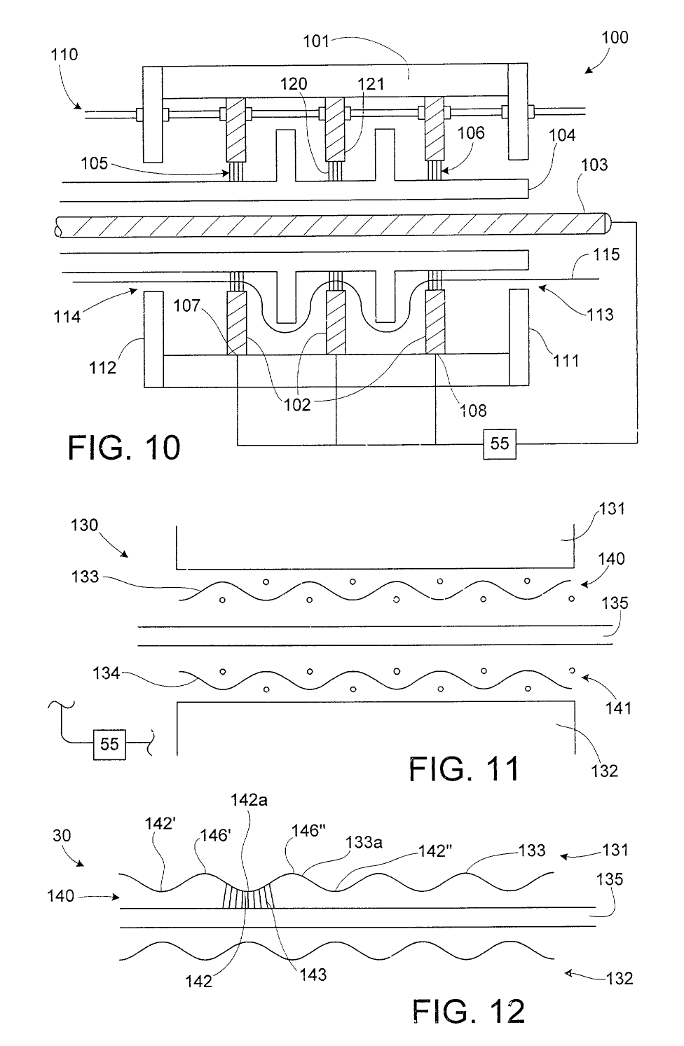

In FIG. 10 is illustrated an embodiment of corona generator system 100 that provides mixer function for the air flow therethrough, e.g., as in a motionless mixer. The system 100 includes a tubular housing 101 in which are located a plurality of electrodes 102 and an electrode 103. The electrode 103 is electrically insulated by a dielectric material or dielectric layer 104 from the electrodes 102, and a gap 105 is provided between the electrodes 102 and the dielectric layer 104. The electrode 103 may be a copper, brass, or other metal tube, and the dielectric layer 104 may be a hollow glass tube. These are examples only and other equivalent materials also may be used. The electrodes 102 preferably are circular metal disks that have a circular hole or opening 106 in the center to provide uniform space for the gap 105 between the respective electrodes 102 and the combination of dielectric layer 104 and electrode 103. The electrode disks 102 also preferably have an edge wall 107 which can engage the housing tube 101 to tend to block flow of air between the electrode disk and the housing wall. Cement or other means may be used to retain the disk electrodes 102 in position adjacent the wall of the housing 101 as is indicated, for example, in the area 108; such material may provide a seal function to help block flow of air at the junction between the disk and the housing. Other means may be used to support the disks in spaced relation to each other and/or to the housing 101, such as, for example, a threaded screw and nut arrangement depicted at 110. End walls 111, 112 close the opposite ends of the housing 101 while leaving a space 113, 114 for air flow 115 into and out from the housing 101. Spacers 116 are mounted on the dielectric layer 104 and cooperate with the disks 102 and housing 101 to establish a tortuous or “mixing” flow path for air through the system 100. The spacers 116 prevent air flow solely along the dielectric layer.

Air flowing generally along a path 115 enters the housing 101 at the entrance 113 and flows along the illustrated tortuous path through the housing. For example, the air initially flows in the gap area 105 formed by the central opening 106 of the disk electrode 102 between the disk itself and the dielectric layer 104. The air then flows out past a spacer 116 and then back into proximity with the dielectric layer 104 and through an opening 106 and gap 105 in the next or downstream disk electrode 102. Eventually the air exits the housing 101 at the exit 114.

In response to energization by the power source 55, which is connected between the disk electrodes 102, on the one hand, and the electrode 103, on the other hand, a corona 120 is created at the gap area between the annular wall 121 of each disk electrode 102 and the dielectric layer 104 in proximity thereto. The air continues to flow along the path 115 and through respective coronas 120.

As is mentioned, the power source 55 may be a pulsed one and the coronas themselves may tend to be correspondingly pulsed. However, it will be appreciated that since the gas flows through several coronas, the treating of substantially all molecules by the corona to ionize the gas will tend to be assured.

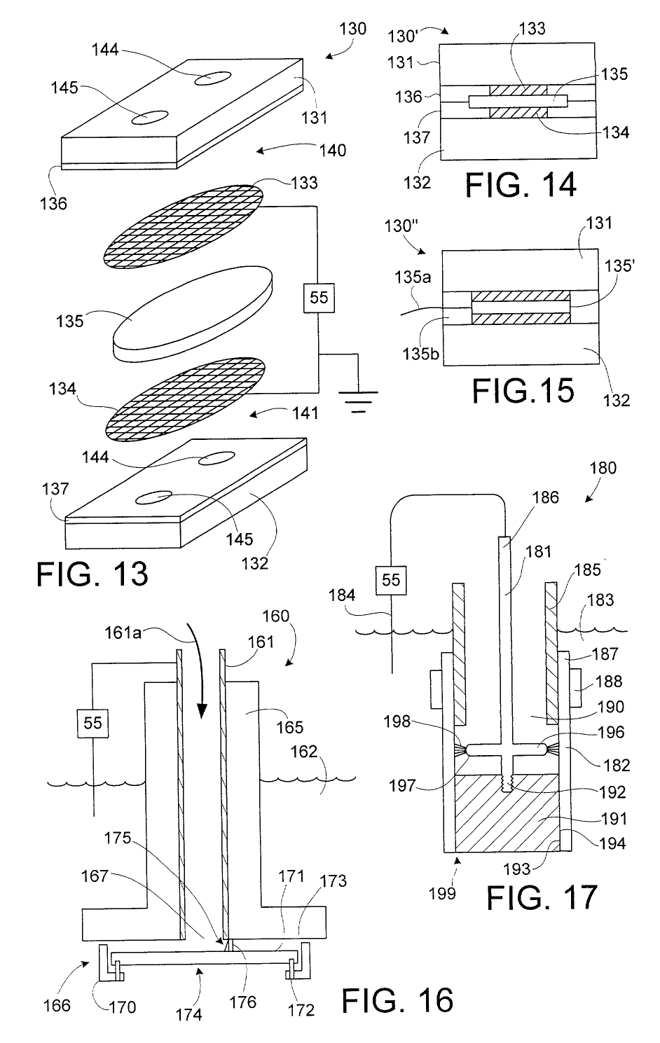

FIGS. 11-15 show another embodiment of corona generator system 130 in accordance with the invention. The system 130 also is in the form of a modified motionless mixer apparatus which provides a plurality of coronas through which air may pass. The system 130 includes a pair of housing blocks 131, 132, a pair of electrodes 133, 134, and a dielectric layer 135. The housing 131, 132 may be of electrically nonconductive material such as a plastic or plastic-like material. If appropriate insulation were provided, the housing blocks 131, 132 alternatively may be of electrically conductive material, such as metal, for example. The electrodes 133, 134 are electrically conductive material, such as a metal. Exemplary electrodes may be of woven screen-like material, such as that used in the conventional window screen. The dielectric layer 135 may be a glass disk or some other dielectric material. Gaskets 136, 137 may be provided to cooperate with the housing blocks 131, 132 and dielectric layer or disk 135 to seal interior chambers 140, 141 (FIG. 11) to prevent leakage of air flow therefrom.

In an alternate embodiment 130′ shown in FIG. 14 one of the electrodes, such as electrode 134, may be replaced by water or other satisfactorily conductive liquid as a liquid electrode of the type described above, for example, with respect to the system 40 in FIG. 3. Various fasteners, such as screws, adhesive material, etc., may be used to fasten together in sandwich relation the several components of this system 130′ to provide a relatively compact package shown in FIG. 14. In another alternate embodiment 130″ the dielectric layer could be replaced by a liquid electrode in a non-conductive container, as is shown at 135′, in FIG. 15, and the liquid electrode 135′ may be coupled by a lead 135a through a non-conductive (dielectric) space 135b to one terminal of the power supply (not shown) and the electrodes 133, 134 coupled to the other terminal.

In operation of the system 130, a power supply 55 supplies electrical energy to the electrodes 133, 134. Coronas are initiated at the places where the undulating wire or screen material forming each electrode are closest to the dielectric layer 135, and the coronas spread laterally, the amount of spread depending at least in part on the joules of energy provided by the power supply. The screen also provides mixing of the fluid. An exemplary area 142 at which a corona 143 is initiated is shown in the enlarged view of the chamber 140 in FIG. 12, and the spread of that corona also can be seen in that drawing figure. Air enters the chamber 140 through an opening 144 in the housing block 131, circulates and flows past the screen electrode 133, and exits the chamber 140 through an air outlet 145. The systems 130′, 130″ of FIGS. 14 and 15 operate similarly to system 130.

The removed air may contain ionized oxygen and/or ozone which can be used for various purposes. An example is to kill bacteria or other organisms in water, e.g., decontaminating, disinfecting or purifying the water.

It also has been found that the system 130, for example, may be supplied with exhaust gases from an internal combustion engine. The treating of the exhaust gases by corona discharge has been found to reduce the hydrocarbon content of those gases in a manner that in some instances at least is more efficient than the conventional catalytic converter treatment of those gases. In particular, since the system 130 can be an instant on device, treatment of the gases may be instantaneous in contrast to treatment by conventional catalytic converters which require the gases and converter to come up to an appropriate temperature in order to achieve the desired treatment. It also will be appreciated that the various other embodiments of the corona generator of the present invention also may be used to treat the exhaust gases from internal combustion engines and/or from other sources to reduce the polluting effect of those gases, e.g., reducing hydrocarbon emission in gaseous form.

It has been discovered that an electrode 133 that is undulating, rippled, woven, etc. type has a unique current limiting effect that helps to prevent burnout, hot spots, undesirable high density current in a corona generator. The migrating of electrons along an electrical conductors, such as electrode 11 shown in the system 10 of FIG. 1 when a discharge occurs, say at 18, can create hot spots, as was described above. The woven electrode 133 shown in the embodiment of FIGS. 11-15 limits such electron migration. With reference to FIG. 12, the area 142 of one strand 133a of the electrode 133 is in close proximity to the dielectric layer 135, and, as was mentioned above, it is at the area 142 that the corona 143 is initiated. The next areas 142′, 142″ of the conductive strand 133a in relatively close proximity to the dielectric layer 135 are separated from the area 142 by peak areas 146′, 146″. The peaks 146′, 146″ are physically relatively distant or remote from the dielectric layer 135 compared to the relative proximity of the areas 142, 142′, 142″ to the dielectric layer 135. Therefore, in a sense the area 142 is a potential well that is located physically between the peaks 146′, 146″. The electrical charge(s) between the peaks 146′, 146″ tend to remain in the potential well 142 and not to migrate to other potential wells, such as those adjacent at 142′, 142″, for example. Therefore, the corona 143 that occurs at the area 142 and potential well thereof is driven only by electrons in that potential well, and the over-feeding of that corona by electrons from other potential wells usually is minimized. As a result, the charge feeding the corona 143 is limited and hot spots tend not to occur.

The corona 143 at the area 142 actually initiates at nearly a point designated 142a, which is the point on the conductor 133a most proximate the dielectric layer 135. Since the corona is initiated essentially from a point, and since charge can be concentrated at that point, the voltage required to initiate the corona can be lower than the voltage required if the electrode 133 were, for example, a flat plate. Since the charge in the potential well 142 is limited due to the self-limiting effect described above, the charge flowing at the point 142a can also effectively is limited to avoid creating a hot spot.

In operation of the system 130, then, air flow is conducted in the chamber 140. The air flow tends to pass through multiple coronas 143 created between the various portions of the electrode 133 and the dielectric layer 135. Also, since the electrode 133 has many open areas and blocked paths due to the woven nature of the conductive material or fibers or strands forming the electrode 133, the electrode 133 tends to provide motionless mixer effect for the air. Therefore, the passing of air through one or more coronas 143 and the thorough mixing of the air as it flows through the chamber 141 is enhanced. Similar operation occurs for any coronas and air flow between the electrode 134 and the dielectric layer 135.

To obtain the maximum benefit of the potential well self limiting effect described, usually it is desirable that the electrode 133 be substantially parallel to the dielectric layer 135 and that the deviations from parallel should not exceed the physical depth of the potential well, e.g., approximately the thickness of the screen electrode 133 minus the thickness of one of the conductors thereof.

In FIG. 16 another embodiment of corona generator is shown at 160. The corona generator includes a first electrode 161, which may be an elongate tube of copper, brass, etc. and a liquid electrode 162, such as water, which may be coupled by an electrical connection 163 to the power source 55. A dielectric cover 165 covers the tubular electrode 161 to separate it from the water 162. A check valve 166 at the outlet end 167 of the tubular electrode 161 permits air flow out from the corona generator 160 and blocks water from entering the corona generator 160, particularly into engagement with the tubular electrode 161. The check valve 166 is formed by a flange 170 at one end of the dielectric cover 165, a glass disk 171, which covers the outlet end 167 of the tubular electrode 161, and fasteners 172 which fasten the disk 171 to the flange 170. The disk 171 may be made of glass or of a material other than glass, although glass has been found particularly suitable due to its dielectric characteristics and stiffness. As a result of such stiffness and the securing of the glass disk 171 to the flange 170 by the fasteners 172, absent suitable air pressure in the tubular electrode 161, the disk seals against the surface 173 of the flange preventing water flow into the tubular electrode 161. However, in response to suitable air pressure in the tubular electrode 161, air flow represented by arrow 161a will slightly deform the glass disk and will pass between the disk and the flange surface 173 to exit into the water 164. Other means may be used to provide such check valve and flow function. For example, the fasteners 172 may be spring loaded to allow the disk 171 to move away from the flange surface 173 under suitable pressure applied in tubular electrode 161. Another example is to use a spring force applied in the area 174 of the glass disk 171 urging the disk against the flange 170 to seal the outlet 167; and in response to suitable air pressure in the tubular electrode 161 to overcome the spring force, air flow may exit the check valve and pass into the water 164. An advantage to the cooperative relation between a relatively stiff disk 171 and a relatively large surface 173 of the flange 170 forming a check valve 166 is the relatively even or uniform distribution of air from the tubular electrode 161 into the water 164 generally about the entire circumference of the disk 171.

In operation of the system 160 the power source 55 is electrically connected to the tubular electrode 161 including an elongate tubular support, as shown, and to the water 162, which serves as the other electrode. The glass disk 171 serves as the dielectric layer referred to above in the other embodiments of corona generator. Air flows through the tubular electrode 161, from the outlet 167, past an area 175 where the air flow is diverted to a direction generally parallel with the disk 171 and surface 173 and out into the water 164. A corona discharge 176 occurs at the area 175. The area 175 generally is of circular annular shape which helps to assure a relatively uniform or balanced distribution of the corona about the exit end of the tubular electrode 161. Several advantages inure to such shape and location. First of all, all air flow must pass through the corona, assuming that the corona is uniformly distributed. Additionally, hot spots are minimized especially when the tubular electrode 161 is of circular cross section as opposed to a rectangular or other polygonal shape. Another advantage to the configuration of the system 160 is the ability to dissipate thermal energy occurring during the corona generating operation. For example, the dielectric layer 171 is in engagement with the relatively large body of water 162, which dissipates heat therein. Also, the tubular electrode 161 may be relatively long and may be thermally conductive, this being especially true if it preferably is an electrically conductive metal; and such tubular electrode tends to be a relatively large heat sink conducting heat away from the area 175 at which the corona discharge 176 is created. Another advantage of the corona generator system 160 is that not only is the passing of air through the corona discharge 176 substantially assured, but also the path length of air through the check valve 166 between the area 175, along the surface 173, and into the water 164 is relatively short, and, therefore, the ionized oxygen created ordinarily will not have sufficient time to recombine as ozone before such ionized oxygen is delivered directly into the water 164 for absorption therein. The transit time between the creating of the ionized oxygen in the corona discharge 176 should be less than one second and preferably significantly less than one second in order to avoid such recombination. Also, it is known that the delivering of ionized oxygen to water for the purpose of purifying the water is more efficient than the delivering of ozone to the water for that purpose. For example, ozone has a relatively poor solubility constant, whereas the solubility of an ion, such as an oxygen ion, is extremely high.

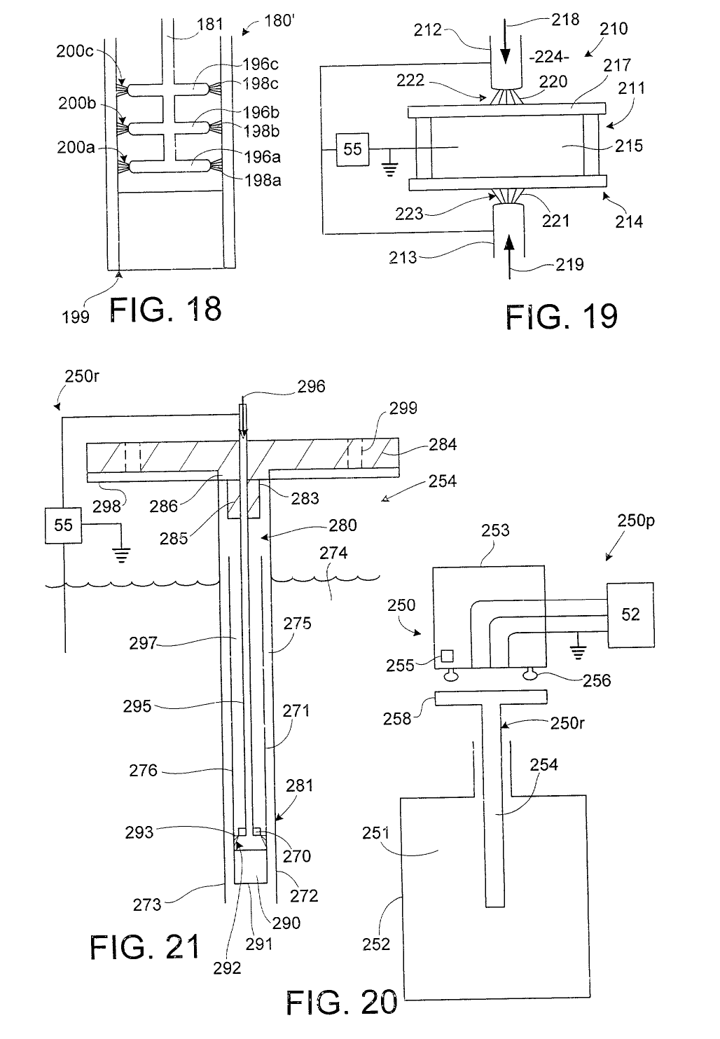

In FIGS. 17 and 18 another embodiment of corona generator system 180 is shown. The system 180 includes an electrode 181, a dielectric layer 182 and a liquid electrode, such as a volume of water in which the system 180 is placed. A connection 184 from the water 183 is made to a power source 55, and the power source 55 also is connected to the electrode 181. A hollow dielectric tube 185 is connected to a source of air flow, such as an air pump (not shown), and the electrode 181 includes a connecting portion or stem 186 that extends in at least part of the dielectric tube 185 and makes connection to the power source 55. An elastomeric tubing 187, such as silicone rubber tubing, for example, or other elastomeric material, is attached to the distal end of the dielectric tube 185. A sealing band 188 may be used to secure the tubing 187 to the dielectric tube 185. Alternatively, if desired, adhesive material or some other means may be used to secure the tubing 187 to the dielectric tube 185. If the tubing 187 has sufficient elastomeric strength, it may be possible to mount the tubing 187 to the dielectric tube 185 without additional means. The connection between the tubing 187 and the dielectric tube 185 should be sufficiently water tight to prevent the flow of water into the interior 190 of the dielectric tube 185.

A plug 191, which may be made of dielectric material, such as a ceramic material, or plastic or plastic-like material, or some other material that preferably is electrically nonconductive, is attached to the distal end 192 of the electrode 181. In the illustrated embodiment such attachment is by way of a threaded connection 192. Other means may be used, such as adhesive material, or some other technique to attach the plug to the electrode. The outer surface 193 of the plug 191 cooperates with the inner surface 194 of the elastomeric tubing 187 to provide a check valve function for the system 80. Preferably the elastomeric characteristics or resilience of the tubing 187 is such that the surface 194 ordinarily engages the surface 193 of the plug 191 forming a check valve to block the flow of water into the interior 190 of the dielectric tube 185 and tube 187. However, in response to a suitable air pressure in such interior, which is represented by the arrow 195, for example, air is forced between the surfaces 193, 194 slightly deforming the elastomeric tube 187 and the air exits into the water 184.

The electrode 181 includes a circular annular portion 196, with edges 197 that are in relatively close proximity to the dielectric layer 182 formed by the tubing 187. In operation of the system 180, upon application of a suitable voltage between the electrode 181 and the water 184, a corona discharge 198 occurs between the edge 197 of the electrode 181 and the nearby interior surface 194 of the tubing 187. Oxygen in the air flowing through the corona discharge is ionized and is directed through the check valve 199 for discharge into the water 184. Preferably the path distance between the corona discharge 198 and the point where the ionized oxygen enters the water is relatively small so that the ionized oxygen reaches the water before recombining into ozone to increase efficiency of the system 180 to reduce contamination of the water. However, if the ionized oxygen does recombine as ozone for reaching the water, such ozone also is known to provide such decontaminating effect.

The corona discharge 198 may create a substantial amount of heat. Advantageously the tubing 187 is directly exposed to water on the outside thereof, and such water provides a cooling effect. Also, the stem 186 of the electrode 181 may provide a heat sink function. Further, desirably the various materials, such as that of the dielectric plug 191 and the dielectric tube 185 should be appropriate to withstand the temperatures resulting from the corona discharge.

Briefly referring to FIG. 18, modified corona generator system 180′ is illustrated. The system 180′ is similar to the system 180 except that the electrode 181 includes a plurality of annular circular portions 196a, b, c, each of which independently can create a corona discharge 198a, b, c. As is illustrated in FIG. 18 each of the circular annular portions 196a, b, c may be of a different respective diameter and, therefore, provide a different size gap 200a, b, c relative to the dielectric layer 182 formed by the tubing 187. The narrowest gap, such as that shown at 200a tends to fire first causing a corona to be created there; the widest gap fires last. Using a pulsed power source 55, the respective coronas will be generated successively in sequence determined by such gap, and that sequence will repeat with delivery of each respective pulse. By timing the pulses, adjusting the gaps, and also adjusting the spacing between respective annular circular portions 196a, b, c to allow for changes in volume of the gas as it goes through the system 180′, a pumping action can occur to pump the gas through the system 180 and out through the check valve 199. The gas tends to expand as it is heated by a respective corona, and controlling the mentioned parameters to accommodate such expansion can be used to optimize the pumping function.

In FIG. 19 another embodiment of corona discharge system 210 is shown. The system 210 includes a water electrode 211 and a plurality of tubular electrodes, two of which are shown at 212, 213. The water electrode 211 may be formed of a dielectric housing 214 containing water 215. As was mentioned above, the water may be replaced by other appropriate liquid to provide electrode function, such as that described above with respect to the system 20 of FIG. 2. The walls 217 of the housing 214 preferably serve as a dielectric layer. Air flows represented by arrows 218, 219, for example, pass through respective tubular electrodes toward the water electrode 211. A power source 55 supplies electrical voltage between the tubular electrodes, on the one hand, and the water electrode 211, on the other hand. As a result, corona discharges 220, 221 occur in the gaps 222, 223 between respective tubular electrodes 212, 213 and the dielectric layer 217 associated with the water electrode 211.

The dielectric layer 217 may be, for example, a cylindrical wall. Also, there may be more than two tubular electrodes 212, 213, each of which provides an appropriate gap between the end of the respective tubular electrode proximate the dielectric layer 217 and such dielectric layer a corona. Therefore, the system 210 is able to handle a relatively large volume of air flow since many tubular electrodes may be used to conduct that air flow through respective coronas, and such coronas provide the desired ionizing of the oxygen in the air to develop ozone that can be distributed into the surrounding environment designated 224 in FIG. 19.

A separate housing may be provided to contain the water electrode 211 and the ends of the tubular electrodes 212, 213, etc., in relative proximity to the water electrode. The housing may serve as a plenum to collect the air flow after such air has passed through respective coronas and to distribute the air flow containing ozone to the external environment 224 or elsewhere where desired.

A corona generator system 250 for use to supply ozone to a liquid 251 in a separate container 252 is shown in FIG. 20. The system 250 is quite portable and can be used with virtually any container 252. Using the system 250 to decontaminate or purify water 251 in a container 252 may result in some precipitating of minerals from the water. Those minerals over time may coat the wall of the container causing an aesthetically unpleasing appearance. Since the system 250 is portable, it can be removed from one container and placed in another. If the former container is undesirably discolored, it may be discarded. Also, the portability of the system 250 allows it to be used to decontaminate water in one container; the container may be placed in storage, e.g., refrigerator, and the system 250 may be used then to decontaminate water in another container, and so on.

Another feature of the corona generator system 250 is the connectability and separability of the power section 250p, which includes power supply 55 and air pump 253, from the reactor 250r, which also includes a flow control mechanism 254. The power section 250p may include a timer 255 to operate the system 250 for a prescribed time period suitable to disinfect the water 251 and also automatically to shut off power to the system 250 to avoid wasting battery power. Since the timer will turn off the power supply after the sufficient time necessary to disinfect the water, this can be a signal to the user that the disinfecting process has been completed.

The ground circuit for the power supply 55 in the section 250p is connected through the reactor 250r and flow control mechanism 254 and disables the power supply unless the components 250p, 250r are interconnected. Lugs, fasteners or the like shown at 256 may connect with each other electrically through the reactor 250r to complete that ground circuit, and only upon such completion will the power supply 55 be operable to supply high voltage to the electrode 257 to operate the system 250. This disabling of the power supply unless the components 250p, 250r are secured together is a safety feature that prevents high voltage from being provided to the electrode 257 unless such electrode is protectively covered by at least part of the reactor 250r and flow control mechanism 254. Also, preferably the external surface 258 of the reactor and flow control mechanism preferably is electrically connected to the ground lugs 256 and ground circuit of the power supply 55 in order to enable an individual to hold the system 250 or to touch various portions of the system 250 to another device without creating a shock hazard.

The reactor 250r and flow control mechanism 254 of the system 250 is shown in more detail in FIG. 21. They include an electrode 270, a tubular dielectric layer 271, and a ground connection 272 between the exterior electrically conductive wall 273 and the water 274 in which the mechanism 254 is immersed. The water 274 may enter an area 275 between the conductive wall 273 and the wall 276 of the dielectric layer 271. Such dielectric layer 271 may be formed of a silicone rubber tube or some other dielectric material. One or more openings 280 in the tube 271 near the top thereof provide a path for air flow into the area 275. Preferably the mechanism 254 is not immersed sufficiently deep in the water 274 as to permit the water to rise in the area 275 to the height of the openings 280. One or more openings 281 in the conductive exterior wall 273 provide an outlet for the air flow. Air flow in the area 275 above the openings 281 will tend to push any water that has risen above the openings 281 down and out of the area 275 above the openings 281. The tube 271 is connected at the top 283 to a support 284. For example, the support 284 includes several stepped walls 285, 286, and the tube 271 is attached at the top 283 to the stepped wall 285, for example, resiliently engaging such wall. The top of the conductive wall 273 is connected to the support 284 at the stepped wall 286. The height of the step between the stepped walls 285, 286 tends to determine the spacing between the wall 276 of the dielectric tube 271 and the conductive cylindrical member wall 273. Various fasteners means, such as bands, adhesive, or the like may be used, if desired, to secure the dielectric tube 271 and/or the conductive wall 273 to the stepped walls 285, 286 of the support 284.

A dielectric plug 290 at the bottom of the dielectric tube 271 may be resiliently held in place by resilient retention provided by the tube 271. The axial dimension, thickness, of the plug 290 preferably is sufficiently great to assure that the electrode 270 is spaced sufficiently far from water in the area of the bottom 291 of the plug not to cause a corona discharge downward through the plug or along the edge of the plug to the water. Therefore, when the system 250 is operated the corona discharge 293 will tend to occur in the gap area 292 between the edge wall of the electrode 270 and the dielectric layer 271, on the opposite side of which is the water electrode in the area 275.

A conductive tube 295 provides support for the electrode 270 at the appropriate location in the reactor 250r and flow control mechanism 254, provides an electrical connection to the electrode from the power source 55, and provides a flow path for air 296 to the gap area 292 for flow through the corona 293 there. The air flow also continues up from the area of the gap 292 in the zone 297 between the conductive tube 295 and the inner wall of the dielectric tube 271. The air passes through the openings 280 through the area 275 and exits out through the openings 281 into the water 274. The passing of air through the corona 293 ionizes oxygen in the air and causes the ozone to be formed, and the ozone may be used for the purpose of disinfecting the water 274 or for some other purpose.

The size and number of openings 281 in the wall of the conductive tube 273 are coordinated with the volume of air flowing through the mechanism 254 from the air pump, as is represented by the arrow 296; therefore, the total quantity of air 296 flowing in the conductive tube 295 will discharge through the openings 281 into the water 274. Preferably the openings 281 are not larger than that just necessary to handle such quantity there, for in that case the air pressure in the area 275 above the openings 281 would drop and the water level in the area 275 would rise possibly impeding air flow, for example. Also, the number of openings 281 should be relatively large, with the constraint of avoiding excess capacity, in order to maximize the distributing of ozone into the water 274. The greater the diffusion of ozone into the water 274 by increasing the number of openings 281, the larger will be the effect of absorption of the ozone and disinfecting function it will carry out. A relatively easy way to determine the total cross sectional area of the some of the openings 281 is to select that sum to be equal to the size of the exit area of the air pump. Consideration also may be given to flow impedance due to walls of such openings.

A conductive plate 298 is mounted on the bottom of the support 284 and is electrically connected to the conductive tube 273. Openings 299 through the support 284 and the conductive plate 297 pass the lugs or screws 256 from the power section 250p and provide a coupling between those lugs thereby to complete a grounding circuit therebetween and to assure that the conductive tube 273 and plate 298 are at relative ground potential to avoid a shock hazard, as was mentioned above.

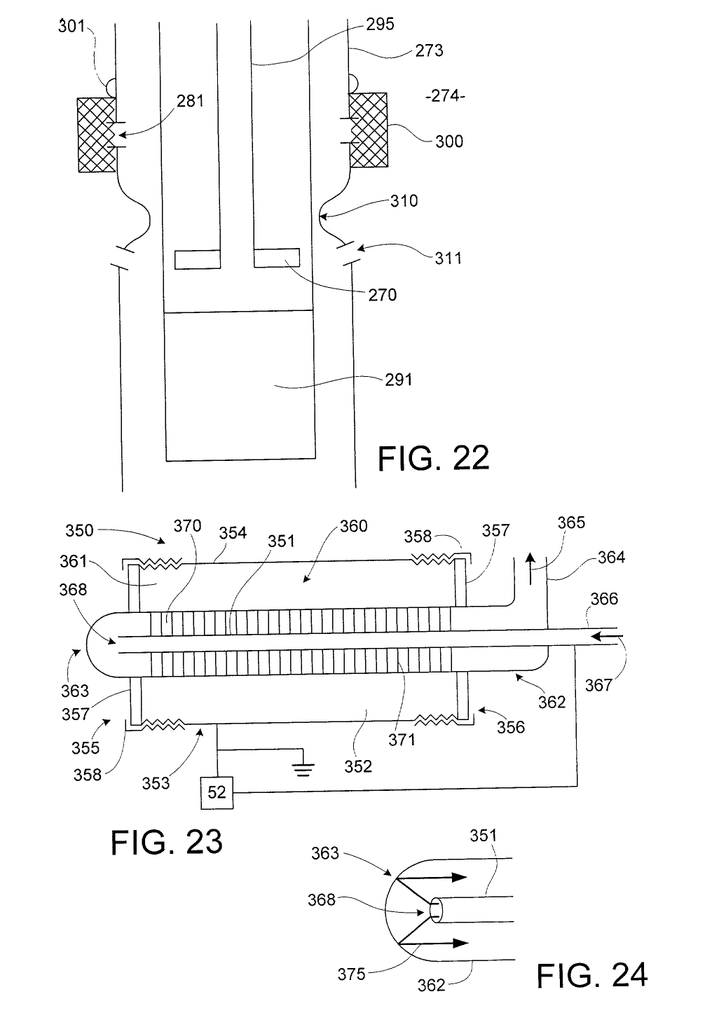

It is desirable to maximize the diffuse distribution of ozone into the water 274. For that purpose it may be useful to place an air stone 300 over the openings 281. The air stone 300, which is shown in FIG. 22, may be an annular air stone of conventional air stone material, such as those made of epoxy and glass beads. The air stone 300 can be slid along the outside of the conductive tube 273 and located to cover the openings 281. A stop, such as a crimp 301 may be provided in the conductive tube 273 to facilitate positioning the air stone over the openings 281. Air containing ozone exiting the openings 281 is diffused by the air stone 300 and is distributed in diffuse manner into the water 274. By increasing the amount of diffusion of the ozone using the air stone 300, the dissolving of the ozone into the water and the disinfecting can be increased.

Another feature of the invention which may be used, for example, in the system 250, is disclosed in FIG. 22 including a crimp or other block 310 in the wall of the conductive tube 273 to prevent water from flowing above the area of the crimp to the area of the openings 281. Vents 311 may be provided in the wall of the conductive tube 273 to facilitate water entering the area 275 to provide the electrode function described above and, thus, to enable the corona 293 to be created in the gap 292, as was described above.

In FIG. 23 is illustrated another embodiment of corona generator system 350. The system 350 includes a pair of electrodes 351, 352, and a housing 353. The housing 353 includes a cylindrical electrically conductive wall 354 and a respective closure 355, 356 at opposite ends of the cylindrical wall 354. The closures 355, 356 may be electrically conductive or non-conductive. In the illustrated embodiment of FIG. 23 the closures are formed of silicone rubber septums 357 and metal fittings 358 which are in threaded connection with the housing wall 354 and are secured sufficiently tight to urge the septums 357 into fluid-tight engagement with ends of the housing wall 354 providing a fluid tight chamber 360 within the housing 353. Water 361 is contained in the chamber 360; such water is engaged with the electrically conductive housing wall 354. A dielectric tube, for example of glass, quartz or some other suitable dielectric material 362 passes through respective openings in the septums 357 and extends generally along the axial length of the housing 353. An end portion 363 of the tube 362 extends beyond the septum 357 at one end of the housing the opposite end of the glass tube 362 passes out through the other end 364 of the glass tube 362 passes out through the septum 357 at the other end of the housing 353 and provides a flow path 365 for air and ozone, for example, from the system 350. The water 361 in the chamber 360 and the housing wall 354 form a self-healing electrode generally of the type described above, for example, with reference to the system 40 of FIG. 3.

The electrode 351 is a hollow electrically conductive tube. The electrode 351 is located generally coaxially within the glass tube 362. At the exposed end 366 of the electrode 351 an air flow from a pump (not shown) is supplied, as is represented by the arrow 367. The distal end 368 of the electrode 351 is located beyond the end of the electrode 352.

In operation of the system 350 air flow 367 enters the electrode 351 and exits the end 368 thereof into the area at the end 363 of the glass tube 362. The air flow then passes through the zone 370 between the outer wall of the electrode 361 and the inner wall of the glass tube 362. The air flow exits the glass tube 362 at the end 364 is represented by the arrow 365. During such air flow a power source 55 supplies a voltage between the electrodes 351, 352 to cause a corona discharge 371 in the zone 370 along the extent of the system 350 that the housing wall 354 and the conductive tube electrode 351 are physically co-extensive. The corona discharge tends not to occur at the end 368 of the electrode 351, for there is no electrode 352 in that area. Therefore, electrical stress or localized discharge there is eliminated and possible damage to the glass tube 362 thereby tends to be avoided.

The corona discharge 371 occurs in the effective gap or zone 370 over a fairly long distance and, therefore, provides a substantial ionizing treatment of the air flowing therethrough assuring a good supply of ozone in the gaseous discharge flow 365 for subsequent use, for example, for disinfecting water.

Preferably the cross-sectional area of the interior volume of the tubular electrode 351 is smaller than the cross-sectional area of the zone 370 in which the air flow returns from the end 363 of the glass tube 362 to the end 364 for discharge. Therefore, the air in the area of the end 363 of the glass tube 362 and also in the zone 370 tends to be at a pressure that is lower than the air pressure delivered from the air pump (not shown). It has been found that a lower voltage from the power source 55 is needed to initiate the corona discharge when the air pressure is reduced, and it has been found that the discharge is more controlled and diffuse or uniform along the substantially full extent along the axial length of the zone 370 which is co-extensive with the electrode 352.

Additionally, a self-centering of the electrode 351 in the glass tube 362 has been experienced. Such self-centering tends to occur due to the relatively high speed jet of air that exits the exit end 368 of the electrode tube 351 and impinges onto the end 363 of the glass tube 362. As is seen in FIG. 24 which is an enlargement of the end 363 of the tube 362, such end roughly approximates the shape of a parabola. By locating the outlet end 368 of the electrode 351 at a location analogous to an optical focal point of a parabolic reflector equivalent of the end 363, the air flow exiting end 368 will tend to deflect/reflect by the glass tube end 363 back in the direction generally parallel to the electrode 351, as is represented by arrows 375. Since the air flow 375 is generally parallel to and of substantially uniform low profile traveling back along the outside of the electrode 351, such flow tends to center that electrode. Since the electrode 351 is centered, the corona discharge 371 in the zone 370 tends to be relatively uniformly distributed 360° about the electrode 351 along the length thereof co-extensive with the electrode 352.

The outlet 364 may be coupled to a hose or tube and from there to an air stone which is located in water to distribute the ozone created by the corona discharge into such water.

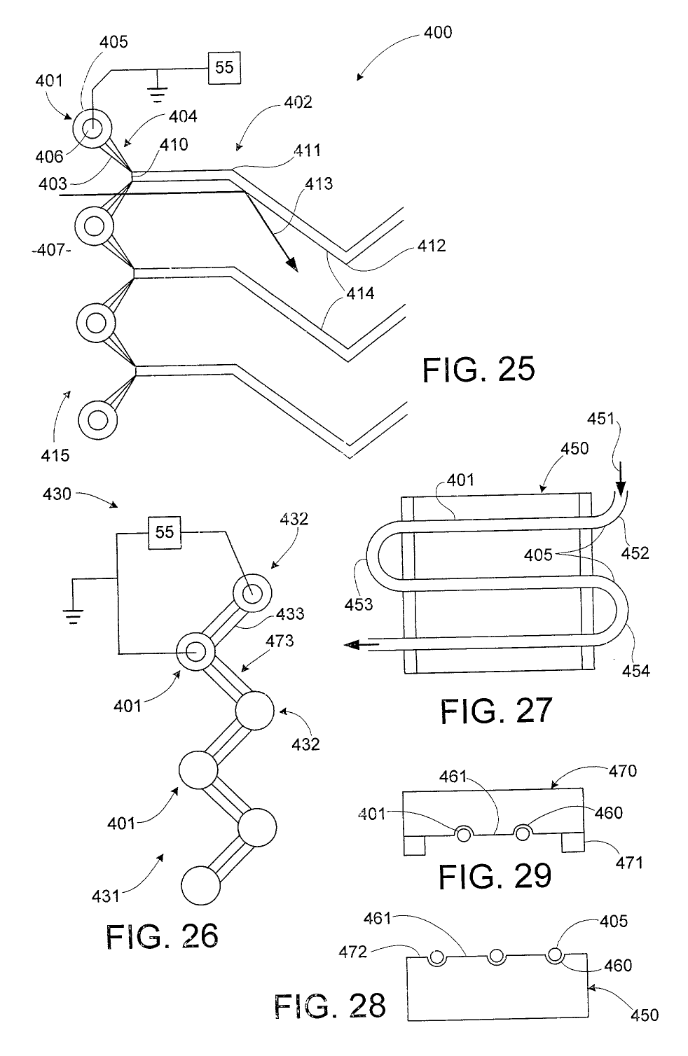

Another corona generator system 400 is shown in FIG. 25. The system 400 is particularly useful to provide a corona curtain to which a fluid flow is intended to pass to treat the material of and/or contained in the fluid medium. The system 400 includes a plurality of first electrodes 401 and second electrodes 402. The electrodes cooperate to provide a corona discharge 403 in respective gaps 404. The first electrodes 401 preferably are water filled electrodes, for example, of one of the various types described above. In the illustrated embodiment of FIG. 25, the first electrodes 401 are formed of glass tubes 405 containing water 406 (or other fluid, preferably an electrically conductive liquid) in the interior volume thereof. A conductor, such as a wire, placed in the water 406 provides a ground circuit connection therefor, or if desired, a “hot” connection. Such connection is coupled to a power source 55, for example. To facilitate heat transfer out of the respective electrodes in order to avoid excessive heating of the fluid medium 407 flowing through the respective coronas 403, the water 406 preferably flows through the glass tubes 405 and transfers heat or conducts heat away from the electrodes and the area of the coronas.

The electrodes 402 in the system 400 of FIG. 25 may be flat metal, such as sheet metal. The corona 403 extends between the electrode 401 and the end 410 of a respective electrode 402. Preferably the metal electrode 402 is bent at one or more places, such as the bends 411, 412. The bends in the respective electrode plates 402 in adjacent electrodes 402 tend to provide a relatively tortuous flow path for the fluid flow 407 preferably to provide impingement surfaces 414. The flow 407 preferably impinges against the impingement surfaces 414 and one or more ingredients of the flow may tend to adhere to the impingement surfaces thereby to be removed from the flow to provide a filtering.

In one example using the system 400, the flow 407 includes volatiles which it is desired to remove before the flow is discharged to external environment. Such volatiles may be produced during an upstream process, such as a coating process, some other reaction process, or the like. It has been found that by directing the volatiles through the corona 403 the volatiles can be made to adhere to the impingement surfaces 414. As one example, the volatiles may be joined with ozone generated in the corona discharge and such ozone causes the volatiles to adhere to the impingement surfaces 414. Alternatively, the corona discharge may change the charge on the volatiles causing the volatiles themselves to adhere to the impingement surfaces. In the latter case the volatiles may be charged or ionized in such a way that they tend not to stick together; by changing charge thereof using the corona discharge, the volatiles can be made to adhere to each other and/or to the impingement surfaces 414. Since the area of the corona discharge tends to be cooled due to water flow through the electrodes 401, which conduct heat away from that area, the temperature elevation of the fluid flow 407 through the corona discharge is relatively minimized so that the fluid, after the volatiles have been removed, can be discharged into the external environment minimizing heat and polluting effects.

As is seen in FIG. 25, the system 400 provides the generating of a plurality of corona discharges to establish in a sense a corona curtain 415. Such corona curtain 415 helps to assure that all of the fluid flow 407 is subjected to corona discharge. The curtain may be used for exhaust gas remediation.

Periodically the electrodes 402 and impingement surfaces 414 and possibly also the electrodes 401 may require cleaning, especially during move deposits from the impingement surfaces. Such cleaning can be effected by applying solvent or other cleaning preparation to the impingement surfaces, electrodes, etc. as may be necessary.

An alternate corona generating system 430 to generate a corona curtain 431 is shown in FIG. 26. The system 430 includes a plurality of first electrodes 401 and a plurality of second electrodes 432. The second electrodes 432 may be elongate tubular electrically conductive members placed in spaced apart relation to the first electrodes 401 generally in the manner shown in FIG. 26. Respective coronas 433 occur between respective pairs of first and second electrodes 401, 432 to form the corona curtain 431. A power source 55 supplies electrical energy with sufficient joules per pulse to establish and to maintain the corona curtain 431. It may be necessary periodically to clean one or more of the electrodes in the system 430 from deposits accumulated thereon. Such cleaning can be carried out using solvents or other cleaning preparations, for example.

In FIG. 27 is shown an exemplary layout for a plurality of water cooled electrodes 401 useful in forming a corona curtain in the system 400, 430 described above. A support structure 450, such as an electrically non-conductive, or dielectric, frame supports the respective glass tubes 405 in parallel spaced-apart alignment. Water 451 from a supply (not shown) is directed by a hose, tube or the like 452 into the first glass tube 405. A further hose 453 at the opposite end of the glass tube 405 couples the flow path from the first tube to the next. Additional hoses, such as the hose 454, etc., provide connections for conducting the water flow through a plurality of additional electrodes (not shown). Ultimately the outlet water may be discharged or may be coo led and recirculated through the electrodes.

End views of the bottom and top (directional reference only being for convenience of description) frame supports 450, 470 are shown in FIGS. 28-30; the frames 450, 470 include a plurality of recesses 460 in which the respective glass tubes 405 of electrodes 401 are placed and positionally retained in the frame. Preferably means are provided to retain the tubes 405 in the recesses 460. Such retention can be provided, for example, by resilient deformation of walls 461, adhesives, such as silicone (not shown) or other means. Even a string or thread, such as a nylon thread, may be used to hold the glass tubes 405 in place as shown in FIGS. 27 and 28.

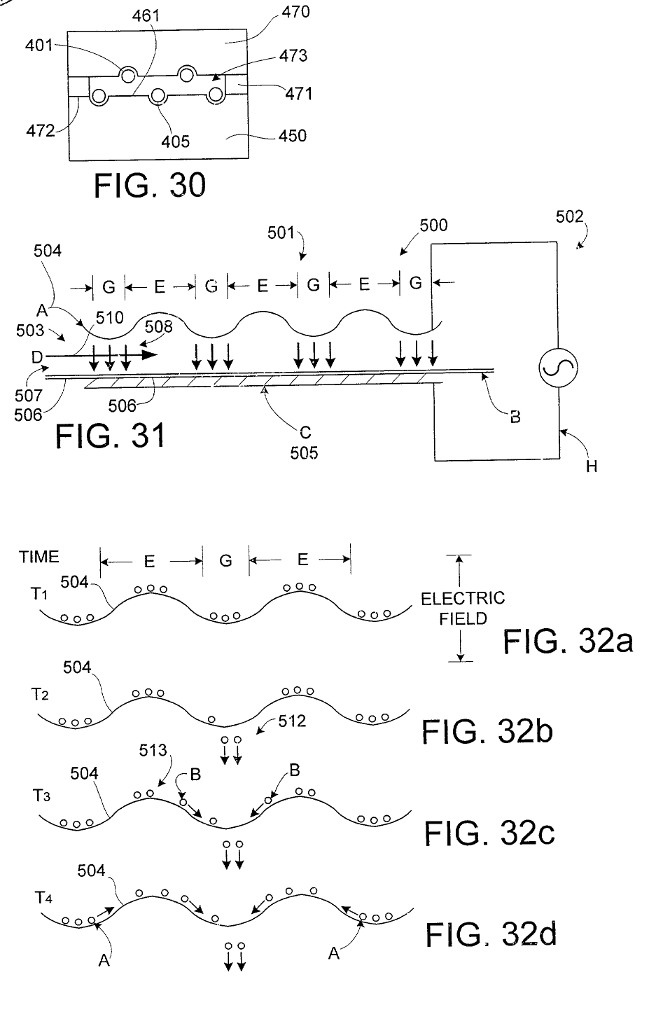

The frame 470 and frame 450 may be placed in confronting relation so that stand off walls 471 engage walls 472 of the support 450 to locate the top electrodes 401 in a stand off relation to the bottom electrodes 401 providing the appropriate gaps 473 in which respective coronas are formed, as is shown in FIG. 30. Fasteners (not shown) may be used to hold the respective support frames 450, 470 together.

The embodiments of the invention of FIGS. 25-30 is especially useful for an exhaust gas remediation process using a corona curtain to remediate exhaust gases flowing therethrough. Other fluids also may be treated in the embodiments disclosed in FIGS. 2530; and exhaust gases and/or other fluids may be used or treated employing the other embodiments disclosed herein.

An ozone reactor or generator when supplied with electrical energy is able to create a corona or electric discharges that will form ozone in oxygen passing through those discharges. Such ozone may be formed directly or by the ionizing of oxygen which combines to form the ozone. In one embodiment the electrical power supply may be conventional line frequency, such as 50 or 60 hertz or some other suitable frequency, and the voltage used is suitable to cause the electric discharges. The voltage may be on the order of several thousand volts, for example, from about 2,500 to about 80,000 volts, which may be provided by an appropriate transformer. A preferred voltage range is on the order of 3,000 volts to about 15,000 volts, and a more preferred voltage range is on the order of from about 3,500 volts to about 10,000 volts. Alternatively, a suitable pulse generator may be used to supply electrical power to the reactor. The pulse power supply may provide pulses of electrical energy that are at a frequency of approximately 25 KHz to 120 KHz and preferably above 40 KHz to as large as is reasonably possible. Suitable wave shaping and pulse forming techniques may be used, as may be desired.

According to one embodiment of the invention a discharge reactor is able to produce ionized fluid or ozone at a flow rate of about ½ cubic foot per hour. The device operates at approximately 10 to 15 watts of power. The approximate gap distances between electrodes is on the order of 1/16 of an inch or less, and the operating voltage is approximately from about 2,500 to about 10,000 volts, preferably as low as possible to obtain the suitable electric discharge and corona producing function. The dielectric may be a glass plate or a glass tube. Alternatively, the dielectric may be a thin film dielectric. If it is desired to decrease the voltage, for example, while still obtaining a sufficient reaction to produce ozone, the length of the reactor or the number of layers in the reactor may be increased to provide a motionless mixer function assuring that the flowing fluid is appropriately treated by electric discharge or corona. It has been found that by increasing the voltage, the number of layers or the length of the reactor can be reduced; an exemplary voltage being 10,000 volts. Also, if the voltage is reduced, for example, to on the order of about 3,500 volts, the number of layers or the length of the reactor should be increased to produce the same quantity of ozone, for example, relative to the amount produced at the higher voltage level. As the voltage is increased, the spray of electrons in the discharge is increased and there is more exposure of the flowing fluid to the electrons, whereas the voltage is reduced, the spray is reduced, and motionless mixer function preferably is increased to assure the same amount of ozone is generated.

Turning now to FIG. 31, the basic configuration of a corona generator in accordance with an embodiment of the present invention is shown at 500. The corona generator 500 sometimes herein is referred to as a reactor. The objective of the reactor is to generate an electric discharge to provide charge to a gas flowing in the reactor. The electric discharge may result in a spray of electrons. The electric discharge may result in the developing of a corona or a corona discharge. Throughout the description of this text, it will be appreciated that reference to generator and reference to reactor may be synonymous. Also, reference to electric discharge and reference to corona or corona discharge also may be synonymous, depending on context, as will be appreciated from the description herein.

The corona generator 500 includes a reactor portion 501 and a power supply 502 (which may be a high voltage alternating current power supply or a high voltage pulsed DC power supply). The power supply 502 may be a 50 or 60 hertz (or other line frequency electrical energy input.) In the illustrated embodiment of FIG. 31, the power supply provides 60 hertz frequency AC signal, and the voltage level is from about 2000 volts to about 10,000 volts.

In operation of the reactor portion 501 it is intended that air 503 be directed into the reactor portion 501 and that corona discharges occur in the reactor portion suitable to cause the oxygen in the air to become ionized and to form ozone. If desired, the ionization of the oxygen may be such as not to form ozone. Also, it may be desired to operate the corona generator 500 to provide a corona discharge or other electrical discharge that affects or does not affect other gases in the air 503. For example, it is preferred that the oxygen be ionized and form ozone but that the nitrogen in the air not be affected or at least not be significantly affected by the electric discharge. Although the corona generator 500 is described hereinafter with respect to use to form ozone from oxygen, it will be appreciated that other gases or fluids may be directed through the corona generator and suitably affected, as may be desired.

The reactor portion 501 includes an input electrode 504 and a counter electrode 505. Typically the AC input signal is supplied to the input electrode 504 from the power supply 502 and the counter electrode 505 is maintained at ground reference potential. In an example described earlier in the text, the counter electrode is water or is in engagement with water. Also, as is described elsewhere herein, the input electrode 504 may be water. In the embodiment illustrated in FIG. 31, the input electrode 504 is a wire of electrically conductive metal material and the counter electrode 505 is electrically conductive metal foil, such as aluminum foil or the like. Other electrically conductive materials also may be used. Several forms in which the electrode(s) may be constructed are described with respect to various exemplary embodiments of the invention both above and below in the text hereof.

A dielectric 506 is located between the electrodes 504, 505. In several embodiments hereof the dielectric 506 is glass material, one example being a glass plate or sheet, another example being a glass tube, and so forth. Alternatively, the dielectric 506 may be another material, such as polyethylene or some other synthetic material or natural material. The dielectric material may be used to provide a spacing between the electrodes so that the electrodes may function as a plurality of capacitors as is described further below. The breakdown voltage of the dielectric material together with the a breakdown voltage of the air 503 flowing in the space 507 between the electrodes and, in particular, between the input electrode 504 and the dielectric 506 is additive with the break down voltage of the dielectric to determine the voltage required to achieve an electric discharge or corona discharge 508.

In operation of the corona generator 500, the power supply 502 supplies an electrical input across the input and counter electrodes 504, 505, and air 503 is directed to flow in the space 507 between the electrodes generally in the direction of the arrow 510. A suitable air pump or other means may be used to direct the air flow as described. The electrical input between the electrodes causes a corona discharge 508 at a number of locations between the input electrode 504 and counter electrode 505. The air flow is directed through those locations to be exposed to the electric discharge of the coronas there so as to become ionized and/or to form ozone. The ozone may be used for various purposes described herein and/or for other purposes.

The voltage must be sufficiently large to exceed the breakdown voltage of the dielectric 506 and the breakdown voltage of the gas 503, such as air, flowing in the corona generator sufficiently to create a corona discharge as is described herein. The voltage may be supplied from the conventional utility lines through a transformer. Alternatively, various types of pulse power supplies may be used which control the pulse width, pulse height, frequency, etc., of the electrical signal supplied to the reactor portion 501 suitable to achieve the corona discharge desired.

As is seen in FIG. 31, the input electrode 504 is an undulating wire that has a number of valleys and peaks respectively spaced closely to and remotely from the counter electrode 505. The wire 504 may be generally of sinusoidal shape or it may be some other shape that provides a desired undulating relationship, such as that shown. The actual radii of curvature of the respective peaks and valleys may be adjusted to a particular shape or size, and the spacing of respective peaks and valleys may be varied, as may be desired to achieve desired operation of the corona generator 500.

In the embodiment illustrated in FIG. 31, the areas designated by the letter “G” are approximately the areas of the valleys or potential wells that are more closely located to the counter electrode 505 than the portions of the wire designated E, which represent respective peaks relatively more remotely located with respect to the counter electrode 505. The areas E are relatively low stress portions of the wire electrode 504 and the areas G are relatively high stress and the places where electric discharge occurs, as is described further below with respect to FIGS. 32a-32d.

Referring to FIGS. 32a-32d, respective illustrations of the wire input electrode 504 are shown at different respective times during operation of the corona generator 500 in one charging and discharging cycle of the power supply 502.

At time T₁ in FIG. 32a, the power supply 502 applies voltage across the input electrode 504 and the counter electrode 506 (not shown in FIG. 32) causing an electric field to be applied between the electrodes. The wire 504 in a sense becomes charged to the voltage V supplied by the power supply 502 relative to the counter electrode. Electrons represented by small circles in FIG. 32a occur at various locations along the wire 504 and are relatively evenly distributed along the wire, or at least evenly distributed at the peaks and valleys E, G, respectively.

As is shown in FIG. 32b, at time T₂ the gas (air) breaks down in the area or space 507 between respective valleys and the counter electrode, and, therefore, the voltage at the valleys G drops. Electrons represented at 512 then discharge through the gas toward the dielectric and counter electrode.

At time T₃ shown in FIG. 32c, some of the electrons 513 at the peaks E of the wire electrode 504 tend to move from the peaks to the valleys to equalize the voltage between the peaks and the valleys. Such electron movement occurs in the direction of the electric field but does not occur in a direction opposite the electric field. (The electric field only is shown in FIG. 32a to simplify the drawings, but it will be appreciated that the electric field also would be applied in each of FIGS. 32b through 32d in the time periods represented thereby.) Since the electrons cannot move against the electric field, i.e., they cannot move from the potential wells G back up the peaks E, the wells in a sense are isolated and become like a plurality of capacitors that are electrically connected in parallel between the input electrode 504 and the counter electrode 505.

The aforementioned operation shown in FIG. 32c at time T₃ shows how the electrons at the peaks E can move with the electric field to the respective wells or valleys G to help continue the discharge there.

However, as is shown in FIG. 32d at time T₄ in the discharge cycle of the corona generator 500, the electrons in the respective wells cannot move out of the wells toward the peaks because such movement would be against the direction of the applied electric field. Therefore, the respective valleys or potential wells G in effect are isolated electrically from each other during the discharge cycle of operation of the corona generator 500. After a particular discharge has been completed, the wire can be recharged by electrons as in FIG. 32a.

From the foregoing, then, it will be appreciated that the valleys or potential wells in the input electrode 504 relative to the counter electrode 505 in effect are electrically isolated from other such potential wells during the discharge cycle of operation of the corona generator 500. Therefore, the electrode 504 tends to function as a plurality of capacitors formed by respective potential wells and the counter electrode with the dielectric 506 and air 503 therebetween.

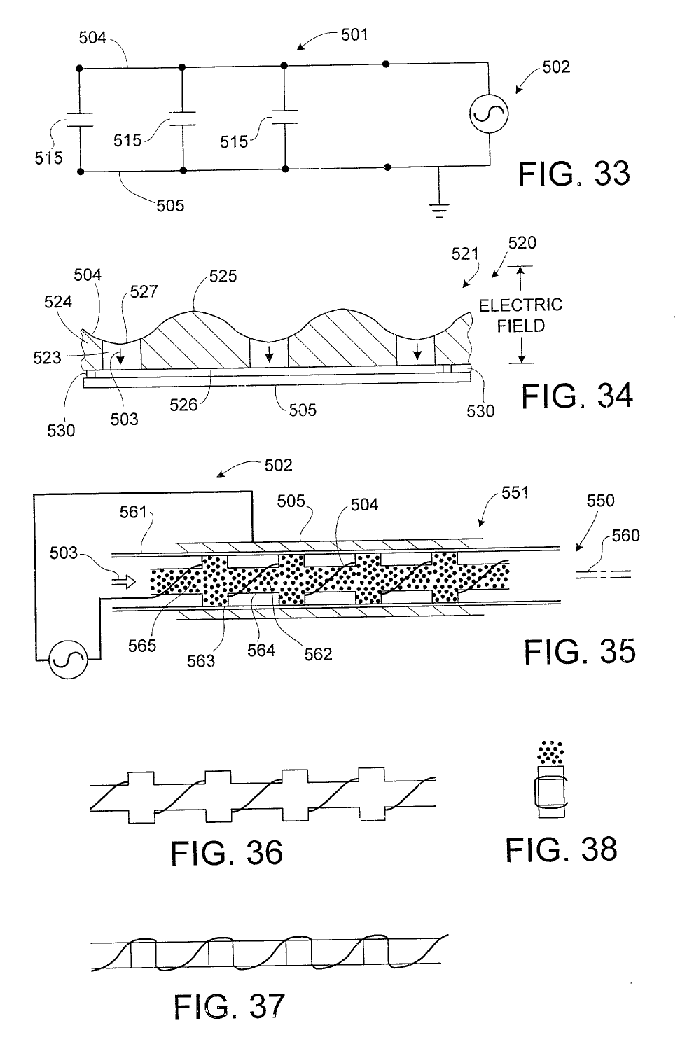

In FIG. 33 the isolating of the capacitors from each other and in a sense having them electrically coupled in parallel across the power supply 502, results in a distributed capacitance effect. The capacitors shown in FIG. 33 at 515 limit the current draw at any one discharge location, such as that represented at 508 (FIG. 31) where a corona discharge occurs, this assuming, then, that a corona is a distributed array of discharges. Accordingly, when discharge occurs, the electrons available for the discharge only are those at the location G and those supplemented by electrodes at the peaks E in the input electrode 504. There is no other source of supply of electrons during such discharge. Therefore, the invention provides a current limiting effect or is a current limiter. Current limiting has the advantage of efficient energy usage and avoids preferential discharges that may cause hot spots and/or damage to the reactor. Also, even though the “capacitors” discharge in parallel, which allows for a rapid, uniform and current limited discharge, they charge in series so charging also is substantially uniform, although slower than the discharge rate due to the difference between time constants for parallel capacitors compared to series capacitors.

A brief comment here regarding the power supply 502 concerns the use of approximately line frequency, such as 50 hertz or 60 hertz AC power or the use of a DC pulse power. The several embodiments of the invention illustrated in FIG. 31 and higher, in particular, provide for mixing of the gas (air) flow through the respective corona generators shown. The mixing of the air and the wiping or washing of the air against one or more of the electrodes and/or against the dielectric helps to dissipate heat. Therefore, the problem of heat build up and dissipation of the built up heat tends to be avoided. In several of the embodiments described earlier, AC line frequency power also can be used provided there is suitable dissipation or removal of heat from the corona generator. However, another option to minimize the effect of heat is to supply the electrodes of the corona generator with DC pulse power that is at a relatively high frequency compared to line frequency, examples being 40 KHz and higher. Since pulsed D.C. power has a portion of time in which no power is being delivered, the heating effect can be reduced. Using pulse power as the power supply, it is desirable to provide the highest frequency that can be generated in which the Joules per pulse is sufficient to ionize the gas at the appropriate location at the desired time to provide for the discharge and the generating of the corona. The voltage required for such a pulse power is approximately the breakdown voltage of the gas, such as air, plus the breakdown voltage of the dielectric; exemplary voltages range from 2.5 KV to 10 KV. Also, it is desirable that energy not be wasted in ramping up the pulse signal, and, therefore, a square wave is desirable for the pulse power. To minimize the ramping portion of the pulse signal, then, the higher the frequency, the steeper the slope of the face of the voltage curve; and a steep face or steep slope tends to look like an almost instant on or square wave signal, which minimizes power wastage.

Turning to FIG. 34, a section view through a fragment or portion of a modified corona generator 520 is shown. The modified corona generator 520 includes a reactor portion 521 and a power supply (not shown). Air or some other gas 503 flows through openings 523 in an electrically non-conductive support 524, such as one made of plastic, ceramic, glass, or other material. The support 524 has a plurality of such openings 523 to provide air flow therethrough. The support 524 also includes a plurality of peaks 525 and a relatively flat surface 526. An input electrode 504, such as a wire, as was described above, follows the undulations at the peaks 525 and at the openings 523 where valleys 527 and the wire 504 occur. A counter electrode 505 is located opposite the smooth face 526 of the support or substrate 524 and is in fixed spaced relation thereto by stand-off feet 530. As the counter electrode 505 may be a metal plate, foil, or other material. Alternatively, the counter electrode 505 may be water or some other electrically conductive liquid into which or against which the surface 526 is placed in such a way that there is a space between the input electrode 504 and the counter electrode 505.

In operation, of the corona generator 520, the power supply 502 (not shown) provides electrical power between the input electrode 504 and counter electrode 505 causing an electric field to be provided as shown in FIG. 34 and as is shown and described above with respect to FIG. 31. Operation of the corona generator 520 is similar to the operation of the corona generator 500. Air is directed through the openings 523 by an air pump or other source of air. As the air flows through the openings 523, the air is exposed to corona discharge and electrons occurring there, and ionization, and/or ozone formation occur. The air then may flow between the surface 526 of the support 524 and the counter electrode 505. Alternatively, if the counter electrode 505 is water, the air may flow directly into the water. Still further, if the counter electrode 505 is other than a solid electrode, the air may flow through that electrode for discharge below it relative to the illustration in FIG. 34. The feet 530 helped to maintain relatively accurate spacing of the counter electrode 505 and the valleys 527 (potential wells) of the input electrode 504.

An advantage to the style of corona generator 520 is that the support 524 relatively accurately defines the locations of the valleys 527 in the input conductor 504 relative to the counter electrode 505. Also, the openings 523 in the support 524 help assure guidance of the air flow into the respective areas where corona is generated to assure exposure thereto.

Another embodiment of corona generator 550 is illustrated in FIGS. 35-38. The corona generator 550 includes a reactor portion 551 and a power supply 502, such as that described above. The reactor portion 551 is intended to conduct air flow 503 through the reactor portion while the air is exposed to corona discharge. The reactor portion 551 is generally elongate cylindrical in construction and shape and has an axis 560 along which the air is directed. Preferably the axis is linear, but it may be curved or some other shape, as may be desired. Similar linear or other shape axes are part of a number of the reactor portions described below with respect a number of other generally tubular corona generators.

The reactor portion 551 includes an input electrode 504 and a counter electrode 505. A dielectric 561, such as a hollow glass tube, for example, or some other hollow tubular device of electrically non-conductive material, for example, is located between the electrodes 504, 505. The input electrode 504 may be an electrically conductive wire or some other electrically conductive material or member, and the counter electrode 505 may be, for example, a metal tube, a metal foil material circumscribing the dielectric 561, or some other electrically conductive material, including, for example, water, as was described above in various embodiments. The wire of the input electrode 504 is wrapped around a holder 562, which has a number of protruding steps 563 and a number of recesses 564 in a generally elongate body 565. The body, steps and recesses are seen in clearly in FIGS. 36-38.

The input electrode 504 is wrapped around the holder 562 generally in the manner illustrated in FIGS. 35-38. The projections 563 of the holder 562 space the wire coils from the dielectric 561 and counter electrode 505 maintaining a relatively accurate distance between the electrodes 504, 505. The holder 562 is made of electrically non-conductive material, such as plastic, glass, ceramic or some other electrically non-conductive material.

In operation of the corona generator 500, in response to electrical energy supplied by the power supply 502, a corona is generated between the input electrode 504 and the counter electrode 505 generally in the manner described above. Relatively accurate spacing of the input electrode 504 by the holder 562 allows the corona to be generated substantially uniformly along the entire length of the reactor portion 551. The shape of the holder 562, including the various protrusions 563 and recesses 564 tends to interfere with smooth flow of air 503 along the axis 560 of the reactor portion 551. Such interference tends to cause a mixing of the air as it flows. Such mixing distributes the ionized material throughout the flow, tends to distribute heat throughout the flow, tends to minimize hot spots in the reactor portion, and helps to assure that substantially all of the air will be exposed to some portion of corona during the flow through the reactor portion 551.

A corona sometimes may be considered a distribution of a plurality of discharges or a distributed array of discharges. Consideration has been given to where the discharges may begin. In fact, it has been found that the discharges may begin virtually at any location in the reactor portion 501. However, due to the occurrence of the first such discharges and corona formation, ultraviolet light usually is emitted. Such ultraviolet energy, light or radiation tends to facilitate the breakdown of other gas in the area of such ultraviolet, and, therefore, the corona discharge expands to other areas of the reactor portion 551. Such corona generation, then, tends to be facilitated throughout the reactor portion 551 and uniformly distributed therein. The air 503 flowing through the reactor portion 551 is exposed to the coronas therein and becomes ionized and/or has ozone formed therein.

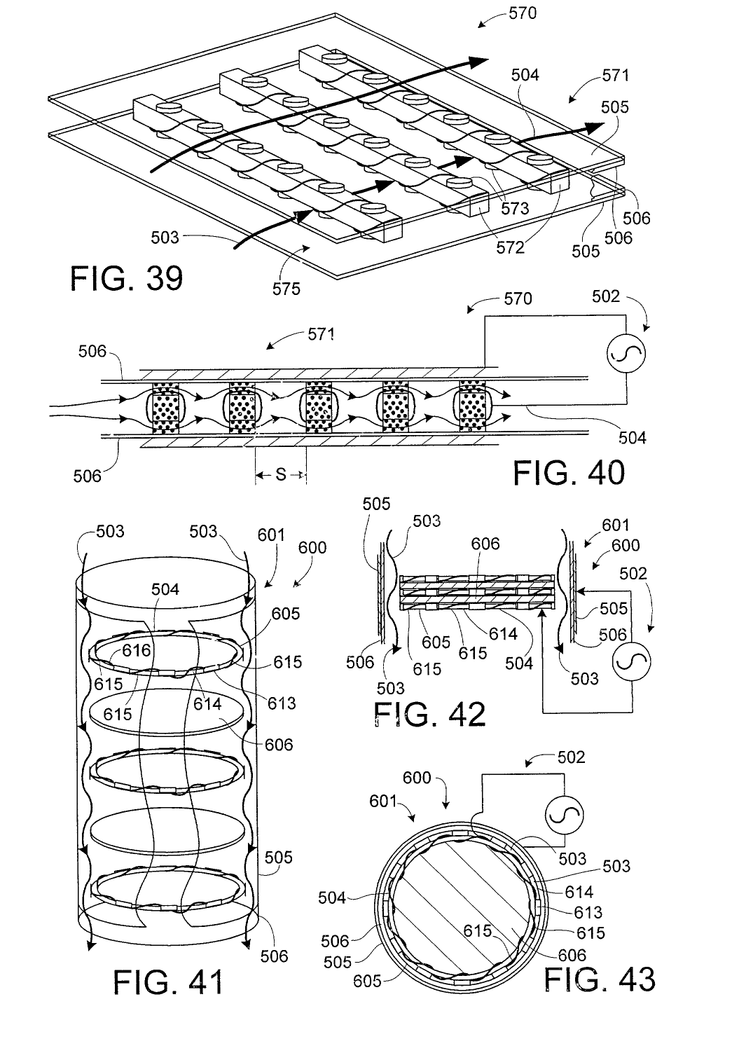

Another embodiment of corona generator 570 is illustrated in FIGS. 39 and 40. The corona generator 570 includes a reactor portion 571 and a power supply 502 (FIG. 40). The power supply 502 may be similar to the power supplies described above.

The reactor portion 571 includes a plurality of input electrodes 504, which may be wires, etc., as was described above, and a pair of counter electrodes 505. The counter electrodes 505 may be foil or an electrically conductive coating on a dielectric sheet 506, such as a glass sheet or other material that is of electrically non-conductive material. Only a portion of the dielectric material 506 is shown in FIG. 39, the dielectric material 506 is shown across the entire extent of the reactor portion 571 in FIG. 40. The input electrode wire 504 is wound about a coil holder 572. In the illustrated embodiment there are several such holders 572, each of which is elongate rectangular cross section and having a plurality of spacer bumps 573 to provide spacing from the respective dielectric sheets 506. The illustrated embodiment shows three such holders 572 in FIG. 39 and five such holders in FIG. 40; and it will be appreciated that there may be more or fewer such holders. Also, in the illustrated embodiment of FIGS. 39 and 40, the input electrode 504 is a single continuous wire wrapped about respective holders 572 in the manner illustrated; alternatively, there may be several such input electrode wires 504, each wrapped around a respective holder 572 or each wrapped around several such holders or several wires wrapped around a single such holder, as may be desired. A flow of air 503 is represented by several arrows in FIGS. 39 and 40.

The holder 572 preferably is made of electrically non-conductive material. The holder provides a support for the input electrode 504. The holder also provides an interference with the air flow through the corona generator 570 to cause mixing of the air as it is flowing through the corona generator. Such mixing of the air helps to assure exposure of all of the air to the corona discharges occurring in the corona generator, removes heat, distributes heat, etc., as was mentioned above, for example. The space between adjacent coil holders 572 may be adjusted from touching to relatively far apart. In FIG. 39, the holders are closer, and in FIG. 40 they are further from each other. However, to maximize the current limiting effect of the corona generator and the effect of potential wells, etc., as was described above, it is desirable that the space between the holders 572 and, therefore, respective coils of the input conductor portions that are most closely positioned to the respective counter electrodes 505, the holders and coils should not touch.

In operation of the corona generator 570, air 503 is directed through the space 575 between the dielectric plates and is exposed to corona therein. The corona is generated in response to energization from the electrical power supply 502 and the current limiting effects described above due to distributed capacitance, etc., limits the current of the corona to avoid breakdown, excessive hot spots, burning out of wires, etc. The holders 572 mix the air as it flows through the corona generator 500.

In an alternate embodiment (not shown), the input electrode 504 may be woven into an electrically non-conductive fabric, such as that known as a plastic canvas in order to form the respective peaks and valleys of the conductor, and the canvas may be placed relative to a dielectric and counter electrode to form a corona generator generally similar to the corona generator 570 of FIGS. 39 and 40. The canvas with the input electrode 504 woven therein is placed between a pair of dielectric or adjacent a single dielectric material 506 in place of the holders 572. As a different alternate embodiment, which also is not shown, the holders 572 may be replaced by a molded plastic egg-crate-like structure about which the input electrode 504 is looped or woven in a manner similar to the wrapping of the input conductor 504 about the holders 572 in the corona generator 570 of FIGS. 39 and 40. The egg-crate support device may have spacer feet or the like thereon, such as those shown at 530 in FIG. 34, for example, to space the egg-crate support and the input conductors from the dielectric 506 plate (or plates) and counter electrode(s) 505 to form a sandwich configuration similar to that shown in FIGS. 39 and 40. In both such alternate embodiments, it will be appreciated that corona is generated between respective potential well portions of the input electrode, for example, and the counter electrode(s). Air is directed through the corona generator, is mixed by interference with the respective support devices and is exposed to the corona.

Turning now to FIGS. 41, 42 and 43, respective somewhat isometric, partially broken away expanded elevation view (FIG. 41), fragmentary section elevation view FIG. and top view FIG. 43 of a circular cylindrical (or circular) corona generator 600 is shown. The actual relation of parts of the corona generator 600 in close proximity is depicted in FIGS. 42 and 43, and in FIG. 41 the parts are spaced apart to facilitate illustration and description.

The corona generator 600 includes a reactor portion 601 and a power supply 502. An air flow 503 is represented by respective arrows in the drawings. The air flows through the reactor portion 601, is exposed to corona discharge therein, and becomes ionized, forms ozone, etc., as was described elsewhere herein.

The reactor portion 601 includes an input electrode 504, such as a wire that is wrapped in the manner illustrated and described below. The reactor portion 501 also includes a counter electrode 505 which is mounted on a dielectric material 506. In this case the dielectric material 506 is a glass tube or cylinder that is hollow, and the counter electrode 505 is an electrically conducting film, such as a coating on the dielectric material, a wrap of electrically conductive metal foil, or some other material.

A plurality of coil holders 605, and spacer disks 606 are positioned in the tubular dielectric glass tube 506. The coil holders 605 include a number of protrusions 613 and recesses 614 about the ring-like structure thereof. Such ring-like structure is analogous to an angular ring about which the input electrode 504 is wound in the illustrated manner. Such winding is about the ring in a somewhat toroidal, serpentine, or sinusoidal configuration. The input electrode 504 is wound closely in engagement with the recess portions 64 and is sinusoidally or helically around the ring of the coil holder being somewhat spaced by the protrusions 613. The protrusions 613 space the ring 605 substantially uniformly from the interior wall of the glass tube 506 and also helps to assure appropriate uniform spacing of respective potential well portions 615 of the input electrode 504 from the glass tube and from the counter electrode 505. Corona discharge occurs between respective areas 615 of the input electrode 504 and the counter electrode 505 while the current limiting effect described above is provided due to portions of the input electrode 504 that are relatively remote from the counter electrode and between respective portions 615 of the input electrode. Such current limiting portions 616, therefore, separate respective portions 615 from each other during such corona discharge cycle.

The spacer disks 606 cooperate with the coil holders 605 to prevent air flow or to minimize air flow in the center of the respective rings of the coil holders 605 and to try to assure that such air flow remains in the space between the recesses 614 of the coil holders 605 and the interior walls of the tubular dielectric glass tube 506. The spacers disks 606 also separate respective coil holder rings 605 from each and prevent the wire (input electrodes 504) of respective rings from touching those of those respective rings, although the wire themselves may be connected in electrical parallel or electrical series, as may be desired.

Operation of the corona generator 600 is similar to the operation described above. The corona is generated between the respective portions 615 of the input electrode 504 and the counter electrode 505. Air flows through the respective corona discharges. The air flow is mixed by the relatively tortuous path provided by the coil holder rings 605 and spacer disks 606. The respective protrusions 613 of respective relatively adjacent coil holder rings 605 may be a non-aligned relative to each other so that the air flow is blocked from a straight path through the reactor portion 501 and instead must deviate around respective protrusions 613 as it flows through the reactor portion. Such deviation causes mixing and the advantages described above.

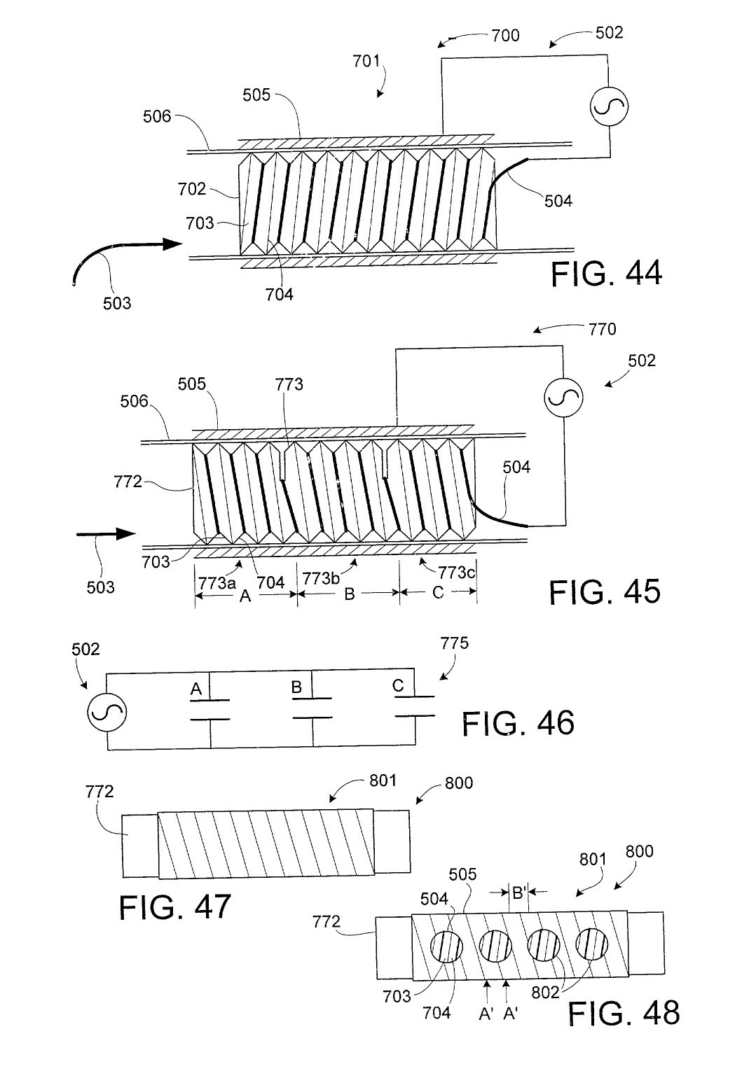

Turning, now, to FIG. 44, another embodiment of corona generator 700 is illustrated. The corona generator 700 operates based on principles similar to those described above with reference to the other corona generators described, although there are a number of differences as are expressed here. The corona generator 700 includes a reactor portion 701 and a power supply 502. The power supply may provide line frequency electrical power at, for example, from about 2,000 volts to about 10,000 volts. Alternatively, the power supply 502 may be a pulsed power supply as was described above.

The reactor portion 701 is intended to pass an air flow 503 through a corona discharge to ionize oxygen in the air, to create ozone, and/or for other purposes. The reactor portion 701 includes an input electrode 504 and a counter electrode 505. The counter electrode is mounted on a tubular dielectric material 506, such as a hollow glass tube, or a tube of electrically non-conductive material other than glass, for example. The dielectric material 506 is electrically non-conductive. The reactor portion 701 also includes a support 702, which in the illustrated embodiment is an electrically nonconductive rod or rod-like member made of glass, plastic, ceramic, or some other electrically non-conductive material. The support 702 preferably has a helical groove 703 formed therein, either during molding or by cutting the groove in the rod, etc., analogous to cutting a thread on a screw or bolt. The thread 703 may be otherwise formed in the rod support 702. The groove 703 preferably is at least one continuous helix or spiral-like configuration. If desired, there may be several continuous grooves of helical or spiral configuration, which may interconnect or it may be relatively isolated from each other formed in the rod support 702.

The groove 703 provides a relatively recessed area in which the input conductor wire 504 may be wrapped. The raised portions 704 of the rod support 702 separate groove recesses 703 and also preferably position the rod support 702 relatively accurately within the dielectric tube 506. For example, the raised portions 704 may engage the interior wall of the tube 506 to position the threaded rod 702 and also to block air flow or to tend to reduce the amount of air flow between the raised portions 704 and the inner wall of the tube 506. Thus, axial air flow directly along the cylindrical axis of the tube 506, for example, tends to be prevented; rather, air flow will tend to follow the groove 703 in a helical fashion about the rod support 702 along the length of the reactor portion 501 for discharge at the end of the reactor remote from the entrance, for example.

The input electrode 504 preferably is a metal wire. However, if desired, the input electrode may be a plated or otherwise formed electrically conductive material in the area of the groove 703. The input electrode 504 may be of some other material. Also, the counter electrode 505 may be a rather an electrically conductive material plated on the outside of the dielectric tube 506 or may otherwise be formed on the dielectric tube 506. Alternatively, the counter electrode 505 may be a foil or some other material, such as was described above and/or is equivalent.

The input electrode 504 preferably is wrapped at the bottom of the thread cut in the non-conductive support 702. Air flows along the passage formed by the apex of the cut thread and the dielectric cylinder glass tube 506. The continuous coil of input conductor wire 504 tends to behave as a single capacitor.

Upon energization of the corona generator 700 by the power supply 502, a corona occurs between the input conductor and the counter electrode 505. It is not known precisely where the corona discharge will commence. However, upon commencing, ultraviolet light usually is produced, and such ultraviolet light will tend to precess about the threaded rod support 702 through the groove 703 to facilitate commencing of the corona discharge along the entire length of the groove 703.

The depth of the groove 703 in the rod sets the spacing of the input electrode from the dielectric and counter electrode and, thus, the trigger voltage to initiate the electric discharge. This also is the case for the other embodiments in which spacing between electrodes is provided or controlled, such as, for example, feet 530 mentioned above. This allows one to hold a relatively close spacing tolerance over long distances.

The glass dielectric tube and/or the counter electrode can enhance the effect of ultraviolet light by reflecting the same back toward the area of the input wire and gas flow. Also, using a glass dielectric tube or other dielectric which effects total internal or other type of reflection of the ultraviolet at the inner surface so the ultraviolet does not have to enter the glass, and, thus, be at least somewhat absorbed, further enhances such ultraviolet effect because it is not absorbed by the glass then. The groove cut in the support and bounded by the glass may be considered in a sense to form an optical wave guide. One can pick the correct diameter and other parameters and angles of the parts to optimize the wave guide effect. Air 503 is directed through the groove 703 and is exposed to the corona discharge.

Turning to FIG. 45, a corona generator 770 is shown. The corona generator 770 is substantially similar to the corona generator 700 of FIG. 44 except that the threaded rod support 772 has a number of cuts 773 therein. The cuts 773 are shown generally perpendicular to the linear or longitudinal axis of the threaded rod and they extend from the exterior surface of the groove 703 radially inward toward the center of the rod support. The depth of the respective cuts 773 may be a matter of choice, depending on the desired operation of the corona generator 770. In the illustrated embodiment of FIG. 45, the cut is approximately from about ¼ the diameter to about ⅓ the diameter of the rod support 772.

It will be appreciated that although the cuts 773 are shown to be only at one radial side of the rod support 772, they may be circumferentially around the rod, e.g., forming an annular recess in a plane perpendicular, or tilted, about the axis of the rod support.

In the corona generator 770 there are three cuts 773; however, there may be more or fewer. The cuts divide or segregate the rod support 772 and the input electrode 504 into several distinct portions 773a, 773b, 773c mechanically and electrically. From a mechanical point of view, the respective portions are separated from each other and provide a recessed area (the cut) between portions where the input electrode wire may be wrapped rather remotely from the counter electrode. From an electrical point of view, the input electrode 504 in effect forms three distinct capacitors similar to those represented at A, B and C in the circuit diagram 775 shown in FIG. 46, which is an electrical analog of the electrical circuit characteristics of the corona generator 770.

Thus, in operation of the corona reactor 770, the regions or portions 773a, 773b, 773c between the cuts 773 act as individual capacitors. The cuts 773 also increase the area of the gas flow passage, which is normally defined by the thread or groove 703 and the interior wall of the dielectric tube 506. This increase in cross sectional area in the cut decreases velocity of the gas therein. The decreased velocity promotes irregular gas flow and, thus, increases gas mixing. Therefore, as the corona occurs in the corona generator 770, the air flows along the path of the helical thread 703, is exposed to the corona, and mixes along the flow path. The mixing is enhanced due to the expansion area provided at the cuts 773.

From the above description, then, it will be appreciated that various embodiments of the invention, including the corona generator 770 and others described herein, have the advantages of providing distributed capacitance and current limiting effect. In the embodiment of corona generator 770, the threaded rod both holds the input electrode 504 (sometimes referred to herein as the coil electrode) and the cuts 773 break up air flow so there is good mixing. Further, since the coil or input electrode 504 at each portion 773a, 773b, 773c, for example, appears in effect as a separate circuit, each operates somewhat independently of the other and helps to assure that corona at each such portion will be generated without regard to operation at the other portions.

As was mentioned above, if desired, the various corona generators described herein may be multiplied, e.g., duplicated, to increase the extent of corona discharge through which the gas, e.g., air, must flow. For example, two of the tubular corona generators 700 or 770, etc., may be positioned physically in fluidic series. The gas would flow through both in series. The input electrodes may be connected to different respective power supplies 502. Alternatively, the input electrodes may be connected to the same power supply to operate in parallel. As a further alternative, the input electrodes may be coupled to the same power supply but in opposite polarity so that when one is positive relative to ground, e.g., the potential at which the counter electrode is maintained, the other is negative with respect to ground. Therefore, the respective coronas would be electrically out of phase with each other by, say, 180 degrees. In each of these examples, the counter electrodes for both corona generator portions may be the same or maintained at the same electrical potential, e.g., ground. Other driving techniques also may be employed.

In FIGS. 47 and 48 are illustrated another embodiment of corona generator 800, which includes a reactor portion 802 and a power supply (not shown). The corona generator 800 is similar to the corona generator 700, except the counter electrode 505′ has a number of holes 802 in it. The holes are discontinuities in the counter electrode and electric field and electric discharge tend not to occur or at least are reduced in the region of the holes 802. The holes 802 produce discontinuities in capacitance. Therefore, separate capacitors in effect are formed by the input electrode 504 and the counter electrode at areas or portions respectively separated by the respective holes 802. The equivalent electrical circuit is similar to that shown at 775 in FIG. 46, except the capacitors would be unequal. That is, the capacitance at the area A′ would be due to a single wire wrap because along the axial length of the support rod 722 at the area A′, for example, there is only wire wrap, each forming a respective capacitor since the counter electrode is discontinuous relative to that wrap. However, the counter electrode is continuous where there is no hole 802; and the capacitance at the area B′ would be due to a double wire wrap of the input electrode 504 because such input electrode faces the counter electrode fully 360° about the circumference of the corona generator. Thus, the capacitors are non-uniform.

The capacitors of the invention in effect charge in series because the input electrode 504 is continuous. Therefore, charging is relatively slow. The capacitors are discharged in parallel, which results in a substantially controlled, but rapid, discharging without a voltage additive effect. Accordingly, controlled discharging occurs rapidly so the corona is maintained and without excessive voltage, which might otherwise cause damage to the corona generator.

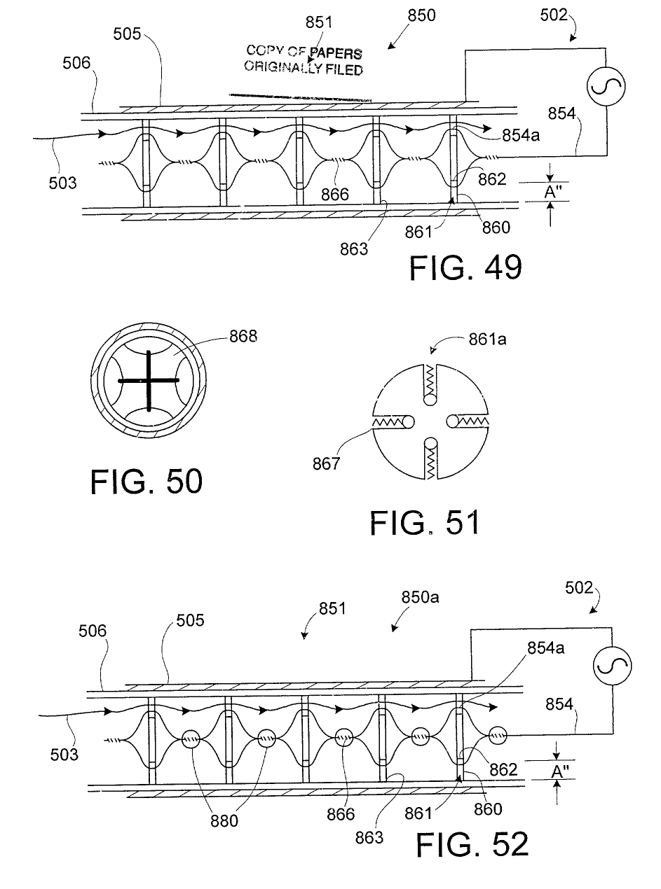

Another embodiment of corona generator 850 is illustrated in FIGS. 49-51. The corona generator 850 incudes a reactor portion 851 and a power supply 502. The reactor portion 851 includes a twisted wire input electrode 854, a counter electrode 505, and a tubular dielectric housing 506, such as a glass tube, etc., for example, as was described above. The reactor portion also includes a plurality of wire holders 860, each of which includes an opening 861 for air flow therethrough and a support surface 862 for supporting a looped part 854a in relatively accurately spaced relation to the counter electrode 505. The holders 860 also include a positioning surface 863 for engaging the interior wall of the dielectric tube 506 to hold position of the holder relative to the dielectric.

The input electrode 584 is formed by several wires, each of which passes through a respective opening 861 of the supports 860 in proximity to a respective support surface 862. In the area 865 between respective holders 860 the input electrode wires 584 are twisted at 866. Therefore, the same operational effect as was described above, vis-a-vis capacitor charging in series and discharging in parallel, is accomplished using the arrangement of input electrodes 584. Each capacitor in effect is at a respective holder 860 where one or several coronas occur during the discharge with respect to the counter electrode, and isolation is provided for respective capacitors due to the potential well effects and isolation thereof described above. However, the respective capacitors formed by the loops 854a at a given holder 860 will charge in series.

During operation of the corona generator 850 air 503 flows along the path through the corona generator deviating through the openings 861 between respective holders 860 so as to mix. Also, the relatively large volume between respective holders, which preferably have solid faces 868 to block air flow without deviation through the openings 861, allows some expansion and mixing of the air. The air is exposed to the coronas in the respective areas of the openings 861 as the input electrode loop portions 854a closes to the counter electrode discharge to cause the coronas there; and the air mixes due to the tortuous flow path and expansion areas provided in the reactor portion 851.

As is illustrated in FIG. 49, there is a gap A″ between the loop portions 854a of the input conductor and the counter electrode 505. If the distance of the gap A″ is kept small, then the discharge between electrodes will be a corona. However, if the distance of the gap A″ is increased, then at some point the discharge becomes an electric arc.

In FIG. 51 is shown a wire holder 861a similar to the wire holder 861, but which is reconfigured having narrow radial slots 867 so that the air is directed more precisely through the arc when it is desired to create such an arc using a relatively large gap A″. The input electrode 854 is wound to pass through those slots as it is positioned to pass through the openings 861 in engagement or proximate the support surfaces 862 so that an electric discharge occurs in the slots 867. The gas flows through the slots for exposure to the electric discharge.

FIG. 52 is an embodiment of corona generator 850a, which is similar to the corona generator 850 of FIGS. 49 and 50, but including an electrically non-conductive bead 880 in the area of the twist 866 of the input electrode wires 854. The bead has an opening through the center, and the wires of the input conductor 854 may pass through the opening. The bead or other similar device helps provide an electrical insulating effect and also provides a disruption of the gas flow path through the reactor portion to enhance mixing thereof.

From the foregoing, then, it will be appreciated that the invention provides for the generating of a corona or other electric discharge and provides for the passing of a gas through the corona to effect ionizing, creating of ozone or the like. The ionized gas, ozone, etc., may be used for various purposes, such as the disinfecting of water or some other material, the filtering of one material, such as iron, minerals, or other materials, from another or other function.

According to various methods of the invention, a corona discharge (or other electric discharge) is created, a gas is passed through the corona discharge; mixing of the gas may be provided by motionless mixing technique for one or more purposes, such as to assure maximum exposure of the gas to the corona discharge, to provide uniform temperature of the gas, to cool the corona generator, etc. According to one of the methods, too, a corona generator has an equivalent circuit of a plurality of capacitors, which may be charged in series and rapidly discharged in parallel.

I claim:

1. A method for disinfecting water, comprising delivering ozone into the water.

2. Apparatus for generating ozone, comprising a plurality of electrodes separated by an electrically non-conductive medium, and wherein the discharge points between electrodes are very small.

3. The apparatus of claim 2, comprising means for accurately supporting and spacing of the electrodes.

4. The apparatus of claim 3, comprising means for setting tolerance limits on the apparatus.

5. Apparatus for generating ozone, comprising means to distribute charge over a large portion of an ozone generator device/reactor to provide substantial uniformity of discharge.

6. The apparatus of claim 5, said means to distribute comrising electrodes and a reactor housing for assuring the flow of gas through the discharge.
